(19) United States
(12) Patent Application Publication
(10) Pub. No.: US 2026/0147286 A1
(43) Pub. Date: May 28, 2026

(54) TONER

(71) Applicant: CANON KABUSHIKI KAISHA, Tokyo (JP)

(72) Inventors: TAKESHI HASHIMOTO, Ibaraki (JP); JUNICHI TAMURA, Ibaraki (JP); MEGUMI SHINO, Chiba (JP); HAYATO IDA, Ibaraki (JP)

(21) Appl. No.: 19/395,682

(22) Filed: Nov. 20, 2025

(30) Foreign Application Priority Data
Nov. 27, 2024 (JP) 2024-206551

(51) Int. Cl. G03G 9/08; G03G 9/087

(52) U.S. Cl. CPC G03G 9/0821; G03G 9/08755

(57) ABSTRACT

A toner comprising a toner particle comprising a binder resin and a wax, wherein the binder resin comprises a crystalline resin, in measuring a viscoelasticity of the toner, the temperature is raised from 30° C. to 100° C. at a rate of 2° C./min to obtain a curve G′₁(T) of storage elastic modulus G′ versus temperature T; then, the temperature is lowered from 100° C. to 30° C. at a rate of 2° C./min to obtain a curve G′₂(T); then, the temperature is raised from 30° C. to 100° C. at a rate of 2° C./min to obtain a curve G′₃(T); the storage modulus at specific temperatures in each curve satisfies the following formulas.

$${G}_{1}^{′} ( 100 ) \leq 5. \times 1 {0}^{4} Pa \qquad ( 1 )$$

$${G}_{3}^{′} ( 50 ) \geq 7.0 \times 1 {0}^{7} Pa \qquad ( 2 )$$

$${G}_{3}^{′} ( 70 ) \geq 2.0 \times 1 {0}^{6} Pa \qquad ( 3 )$$

$${G}_{3}^{′} ( 70 ) / {G}_{2}^{′} ( 70 ) \geq 10 \qquad ( 4 )$$

### BACKGROUND

### Field of the Technology

The present disclosure relates to toner for use in electrophotography, electrostatic recording, electrostatic printing, and toner jet printing.

### Description of the Related Art

In recent years, there has been a strong demand for low power consumption in electrophotographic devices such as full-color printers and full-color copiers in order to realize a low-carbon society.

To achieve low power consumption, it is important to melt toner at lower temperatures during the fixing step. Therefore, improving sharp melt property is carried out by comprising a crystalline resin in a binder resin of the toner.

However, the toner comprising the crystalline resin may have poor storability at high temperatures or may adhere strongly to a photosensitive member, resulting in image defects (fusion to a drum). Furthermore, the solidification of melted toner during the fixing step may be slow, which can cause defects (phenomenon of ejected paper adhesion) due to the transfer of portions of fixed images to other recording media or adhesion of fixed images to each other when output recording media are stacked.

To suppress the phenomenon of ejected paper adhesion, for example, Japanese Patent Laid-Open No. 2019-194682 discloses a toner comprising an amorphous polyester having an alkyl group with a specific number of carbon atoms at a terminal and a crystalline polyester composed of a specific number of carbon atoms.

Furthermore, Japanese Patent Laid-Open No. 2019-056767 discloses a toner with a complex viscosity that, when measured by dynamic viscoelasticity measurement using different thermal processes, falls within a specific range.

The toners described in the above documents appear to be somewhat effective in suppressing the phenomenon of ejected paper adhesion. However, according to the research conducted by the inventors, during double-sided printing, image defects (hereinafter referred to as double-sided printing image defects) may occur when part of the fixed image comes into contact with and transfers to a member that contacts a recording medium in an electrophotographic device.

### SUMMARY

The present disclosure relates to a toner that has excellent low-temperature fixability and heat-resistant storage stability, is resistant to fusion to a drum, and can suppress double-sided printing image defects.

The present disclosure relates to a toner comprising a toner particle comprising a binder resin and a wax, wherein
the binder resin comprises a crystalline resin;
in measuring a viscoelasticity of the toner,
step (i): the temperature is raised from 30° C. to 100° C. at a rate of 2° C./min to obtain a curve G′₁(T) of storage elastic modulus G′[Pa] versus temperature T [° C.],
step (ii): after the step (i), the temperature is lowered from 100° C. to 30° C. at a rate of 2° C./min to obtain a curve G′₂(T) of storage elastic modulus G′[Pa] versus temperature T [° C.],
step (iii): after the step (ii), the temperature is raised from 30° C. to 100° C. at a rate of 2° C./min to obtain a curve G′₃(T) of storage elastic modulus G′[Pa] versus temperature T [° C.]; and
where the storage elastic modulus G′ at 100° C. on the curve G′₁(T) is denoted by G′₁(100) [Pa], the storage elastic modulus G′ at 70° C. on the curve G′₂(T) is denoted by G′₂(70) [Pa], the storage elastic modulus G′ at 50° C. on the curve G′₃(T) is denoted by G′₃(50) [Pa], and the storage elastic modulus G′ at 70° C. on the curve G′₃(T) is denoted by G′₃(70) [Pa],
the G′₁(100), the G′₂(70), the G′₃(50), and the G′₃(70) satisfy the following formulas (1) to (4).

$${G}_{1}^{′} ( 100 ) \leq 5. \times 1 {0}^{4} Pa \qquad ( 1 )$$

$${G}_{3}^{′} ( 50 ) \geq 7.0 \times 1 {0}^{7} Pa \qquad ( 2 )$$

$${G}_{3}^{′} ( 70 ) \geq 2.0 \times 1 {0}^{6} Pa \qquad ( 3 )$$

$${G}_{3}^{′} ( 70 ) / {G}_{2}^{′} ( 70 ) \geq 10 \qquad ( 4 )$$

The present disclosure can provide a toner that has excellent low-temperature fixability and heat-resistant storage stability, which is less prone to fusion to a drum, and can further suppress double-sided printing image defects.

Features of the present disclosure will become apparent from the following description of embodiments. The following description of embodiments is described by way of example.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In addition, in the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ. If XX is a group, it is permissible to select multiple items from XX, and the same applies to YY and ZZ.

In the present disclosure, the crystalline resin refers to a resin that shows a clear endothermic peak in differential scanning calorimetry (DSC) measurement. The “monomer unit” refers to the reacted form of a monomer substance in a polymer.

The toner of the present disclosure is described in detail below.

The present disclosure relates to a toner comprising a toner particle comprising a binder resin and a wax, wherein
the binder resin comprises a crystalline resin;
in measuring a viscoelasticity of the toner,
step (i): the temperature is raised from 30° C. to 100° C. at a rate of 2° C./min to obtain a curve G′₁(T) of storage elastic modulus G′[Pa] versus temperature T [° C.],
step (ii): after the step (i), the temperature is lowered from 100° C. to 30° C. at a rate of 2° C./min to obtain a curve G′₂(T) of storage elastic modulus G′[Pa] versus temperature T [° C.],
step (iii): after the step (ii), the temperature is raised from 30° C. to 100° C. at a rate of 2° C./min to obtain a curve G′₃(T) of storage elastic modulus G′[Pa] versus temperature T [° C.]; and
where the storage elastic modulus G′ at 100° C. on the curve G′₁(T) is denoted by G′₁(100) [Pa], the storage elastic modulus G′ at 70° C. on the curve G′₂(T) is denoted by G′₂(70) [Pa], the storage elastic modulus G′ at 50° C. on the curve G′₃(T) is denoted by G′₃(50) [Pa], and the storage elastic modulus G′ at 70° C. on the curve G′₃(T) is denoted by G′₃(70) [Pa],
the G′₁(100), the G′₂(70), the G′₃(50), and the G′₃(70) satisfy the following formulas (1) to (4).

$${G}_{1}^{′} ( 100 ) \leq 5. \times 1 {0}^{4} Pa \qquad ( 1 )$$

$${G}_{3}^{′} ( 50 ) \geq 7.0 \times 1 {0}^{7} Pa \qquad ( 2 )$$

$${G}_{3}^{′} ( 70 ) \geq 2.0 \times 1 {0}^{6} Pa \qquad ( 3 )$$

$${G}_{3}^{′} ( 70 ) / {G}_{2}^{′} ( 70 ) \geq 10 \qquad ( 4 )$$

After extensive research, the inventors have discovered that the above-mentioned problems can be solved by controlling the viscoelasticity of a toner comprising a crystalline resin within the above-mentioned specific range. Specifically, this toner makes it possible to achieve excellent low-temperature fixability and heat-resistant storage stability and to suppresses image defects during double-sided printing and fusion to a drum during long-term durability at low print percentage.

The background to the development of this toner is as follows:

Toner is heated and melted in the fixing step, and then cooled to solidify and form a fixed image.

During double-sided printing, a fixed image formed on one side of an image medium is heated again in the fixing step on the back side. Where the storage elastic modulus of the fixed image formed on one side is low, when the fixed image comes into contact with other components, such as transfer members or transport members, during double-sided printing, part of the fixed image may be transferred to those components, resulting in poor image quality.

When a toner comprising a crystalline resin is melted and then cooled during the fixing step, some of the crystalline resin may solidify without crystallizing. It is speculated that such crystalline resin is likely to act as a plasticizer in the fixed image, which may apparently lead to the transfer of the fixed image to other components during double-sided printing. While there are methods to further promote the crystallization of the crystalline resin, such as adding a nucleating agent, it is difficult to eliminate the uncrystallized crystalline resin component.

Accordingly, the inventors have assumed that it is important to improve the strength of the fixed image, even if the uncrystallized crystalline resin is present. The inventors have found that, as an indicator of fixed image strength, the storage elastic modulus of a toner sample that was once melted and then solidified closely correlates with the strength of the fixed image. However, simply increasing the storage elastic modulus of toner impairs low-temperature fixability. As a result of producing and extensively testing various toner prototypes, it was found that toners with excellent low-temperature fixability and a high storage elastic modulus at 70° C. during the second temperature rise cycle have a lower storage elastic modulus at 70° C. when the temperature is lowered than when it is raised. This finding led to the development of the above-described toner.

The toner of the present disclosure has the following characteristics.

In measuring a viscoelasticity at 1% strain of toner, the following steps (i) to (iii) are performed.

Step (i): The temperature is raised from 30° C. to 100° C. at a rate of 2° C./min to obtain a curve G′₁(T) of storage elastic modulus G′[Pa] versus temperature T [° C.].

Step (ii): After the step (i), the temperature is lowered from 100° C. to 30° C. at a rate of 2° C./min to obtain a curve G′₂(T) of storage elastic modulus G′[Pa] versus temperature T [° C.].

Step (iii): After the step (ii), the temperature is raised from 30° C. to 100° C. at a rate of 2° C./min to obtain a curve G′₃(T) of storage elastic modulus G′[Pa] versus temperature T [° C.].

Then, the storage elastic modulus G′ at 100° C. on the curve G′₁(T) is specified as G′₁(100) [Pa]. The storage elastic modulus G′ at 70° C. on the curve G′₂(T) is specified as G′₂(70) [Pa]. The storage elastic modulus G′ at 50° C. on the curve G′₃(T) is specified as G′₃(50) [Pa], and the storage elastic modulus G′ at 70° C. on the curve G′₃(T) is specified as G′₃(70) [Pa],

At this time, the G′₁(100), the G′₂(70), the G′₃(50), and the G′₃(70) satisfy the following formulas (1) to (4):

$${G}_{1}^{′} ( 100 ) \leq 5. \times 1 {0}^{4} Pa \qquad ( 1 )$$

$${G}_{3}^{′} ( 50 ) \geq 7.0 \times 1 {0}^{7} Pa \qquad ( 2 )$$

$${G}_{3}^{′} ( 70 ) \geq 2.0 \times 1 {0}^{6} Pa \qquad ( 3 )$$

$${G}_{3}^{′} ( 70 ) / {G}_{2}^{′} ( 70 ) \geq 10. \qquad ( 4 )$$

In measuring the viscoelasticity of the above-described toner, step (i) simulates the behavior of the toner in the process in which the toner is heated during the fixing step. Step (ii) simulates the behavior of the toner in the process in which the toner is cooled after being heated and melted. Step (iii) simulates the behavior of a solidified fixed image when reheated during double-sided printing.

The toner is characterized by G′₁(100)≤5.0×10⁴ Pa. Since G′₁(100) is the storage elastic modulus G′ at 100° C., satisfying formula (1) indicates that the storage elastic modulus of the toner becomes sufficiently low in the fixing step.

Having G′₁(100) within the above range ensures excellent low-temperature fixability. From the viewpoint of achieving both low-temperature fixability and hot offset resistance, it is preferable that 1.0×10³ Pa≤G′₁(100)≤5.0×10⁴ Pa, and more preferably 1.0×10³ Pa≤G′₁(100)≤2.0×10⁴ Pa.

The value of G′₁(100) can be controlled by the melting point and content of the crystalline resin. It can also be controlled by the glass transition temperature and softening point of resins used other than the crystalline resin, and the melting point and content of wax.

The value of G′₁(100) can be easily increased, for example, by reducing the content of the crystalline resin or raising the glass transition point and softening point of resins used other than the crystalline resin. The value of G′₁(100) can also be easily decreased, for example, by setting the melting point of the crystalline resin at or below 100° C. or by increasing the content thereof. The value of G′₁(100) can also be easily reduced by using a low-softening-point resin other than the crystalline resin. Furthermore, the value of G′₁(100) can also be easily reduced by setting the melting point of the wax below 100° C. and increasing the wax content.

The toner is characterized by satisfying formula (4), i.e. G′₃(70)/G′₂(70)>10. Satisfying formula (4) indicates that there is a 10-fold or greater difference between the storage elastic modulus of the toner during the cooling process after melting and the storage elastic modulus during the subsequent temperature rise process.

The inventors speculate that the toner exhibits this behavior according to the following mechanism.

Where the toner is cooled after melting, the toner begins to crystallize near the crystallization temperature. The crystallization temperature can be measured by the peak-top temperature of an exothermic peak associated with crystallization that is observed when the temperature is lowered in differential scanning calorimetry (DSC) described hereinbelow. As the crystalline resin begins to crystallize, the content of solid components in the toner increases, and the storage elastic modulus of the toner also increases. It is believed that at this time, the crystalline resin does not crystallize on its own, but rather proceeds to crystallize while interacting with other molten binder resins located therearound.

The inventors speculate that this interaction causes a slower increase in the storage elastic modulus compared to when there is no interaction with other binder resins. This results in a smaller G′₂(70). It is speculated that a slower increase in the storage elastic modulus allows the crystalline resin to achieve a state of high molecular mobility, making it easier to achieve a molecular chain arrangement that results in a crystalline state closer to the ideal one. It is believed that the fixed image solidified through this process becomes strong, resulting in a larger G′₃(70), and the relationship G′₃(70)/G′₂(70)≥10 can be achieved.

Preferably, G′₃(70)/G′₂(70)≥20, more preferably, G′₃(70)/G′₂(70)≥38, and even more preferably, G′₃(70)/G′₂(70)≥40. Where G′₃(70)/G′₂(70) is less than 10, image defects are likely to occur during double-sided printing. Furthermore, G′₃(70)/G′₂(70) is, for example, 10 to 100, preferably 20 to 90, more preferably 38 to 80, and even more preferably 40 to 75.

As described hereinbelow in the section relating to raw materials, one method for controlling the value of G′₃(70)/G′₂(70) is to introduce a structure having an alkyl group at the molecular chain terminal of the crystalline polyester resin. Another method is to introduce a monomer unit corresponding to a linear aliphatic carboxylic acid into a binder resin other than the crystalline resin.

Furthermore, the toner is characterized by satisfying formula (2), i.e. G′₃(50)≥7.0×10⁷ Pa.

Where G′₃(50) is within the above range, the heat-resistant storage stability of the toner is improved. Preferably, G′₃(50)≥9.0×10⁷ Pa, and more preferably, G′₃(50)≥1.0×10⁸ Pa. Where G′₃(50) is less than 7.0×10⁷ Pa, the heat-resistant storage stability of the toner decreases.

Here, in a toner comprising a crystalline resin, the crystalline resin within the toner is more likely to crystallize with the passage of time after the toner is manufactured. As a result, the numerical value of G′₁(50) tends to increase with the increase in storage duration, so that the heat-resistant storage stability of toners can be impossible to compare accurately. For this reason, in the present disclosure, the G′₃(50) value is used as an index that can evaluate heat-resistant storage stability without substantially considering the influence of storage duration. The value of G′₁(100) and the values of G′₂(T) and G′₃(T) are not affected by the toner storage duration.

G′₃(50) is, for example, 7.0×10⁷ to 7.0×10⁹ Pa, preferably 9.0×10⁷ to 4.0×10⁹ Pa, and more preferably 1.0×10⁸ to 2.0×10⁹ Pa.

Furthermore, the toner is characterized by satisfying formula (3), i.e. G′₃(70)≥2.0×10⁶ Pa. Having G′₃(70) in this range can suppress image defects during double-sided printing. Preferably, G′₃(70)≥5.0×10⁶ Pa, and more preferably, G′₃(70)≥7.0×10⁶ Pa. Where G′₃(70) is less than 2.0×10⁶ Pa, image defects during double-sided printing cannot be suppressed.

G′₃(70) is, for example, 2.0×10⁶ to 9.0×10⁷ Pa, preferably 5.0×10⁶ to 4.0×10⁷ Pa, and more preferably 7.0×10⁶ to 3.0×10⁷ Pa.

The values of G′₃(50) and G′₃(70) can be controlled by changing the melting point and content of the crystalline resin and the type, glass transition point, weight-average molecular weight of THF-soluble fraction and content of the binder resin other than the crystalline resin.

G′₃(50) can be easily increased, for example, by raising the glass transition point of the binder resin other than the crystalline resin, increasing the weight-average molecular weight of the binder resin, or decreasing the content of the crystalline resin.

G′₃(70) can be easily increased, for example, by introducing a structure having an alkyl group at the molecular chain terminal of the crystalline polyester resin, or by further incorporating an amorphous polyester resin into the binder resin and introducing an alkyl group at the molecular chain terminal.

Furthermore, in a graph of the curve G′₂(T) in which the horizontal axis represents the temperature T and the vertical axis represents a value d(log G′₂(T))/dT obtained by differentiating log G′₂(T) with respect to the temperature T, it is preferable that a minimum value be present in the range of 55.0 to 70.0° C.

In addition, where the temperature at which the minimum value is observed is denoted by T2 (° C.), it is preferable that d(log G′₂(T2))/dT be −2.0 to −0.3.

In the above graph, having a minimum value in the range of 55.0 to 70.0° C. means that there is a point in the range of 55.0 to 70.0° C. where the storage elastic modulus increases sharply in the process in which the toner is cooled after melting. Furthermore, d(log G′₂(T2))/dT indicates the magnitude of the change in the storage elastic modulus, with the larger absolute value thereof indicating a steeper change. The fact that d(log G′₂(T2))/dT is in the range of −2.0 to −0.3 indicates that the storage elastic modulus increases sharply in the process in which the toner is cooled after melting.

A steep increase in the storage elastic modulus in the range of 55.0 to 70.0° C. is facilitated by achieving a molecular chain arrangement that results in a crystalline state closer to the ideal one while the crystalline resin in the molten toner interacts with other binder resins during cooling. This makes it easy to control the value of G′₃(50) within the above range.

In the above graph, a minimum value T2 of 55° C. or higher increases the elastic modulus of the image, making it easier to further suppress image defects during double-sided printing. Furthermore, a minimum value T2 of 70.0° C. or lower facilitates the interaction of the crystalline resin with other binder resins, making it easier to suppress image defects during double-sided printing.

The minimum value T2 is more preferably 57.0 to 68.0° C.

Furthermore, d(log G′₂(T2))/dT is more preferably −2.0 to −0.4, even more preferably −2.0 to −0.5, and still more preferably −1.3 to −0.5.

T2 can be changed by controlling the temperature at which the crystalline resin interacts with other binder resins. Specifically, the value of T2 can be lowered by lowering the melting point of the crystalline resin or the glass transition point of the amorphous resin. The value of T2 can also be lowered by raising the melting point of the crystalline resin or the glass transition point of the amorphous resin.

As for a method for controlling d(log G′₂(T2))/dT within the above range, the absolute value increases when the degree of interaction between the crystalline resin and the other binder resins is high, and decreases when the degree of interaction is low. d(log G′₂(T2))/dT can be controlled by changing the structure, melting point, or molecular weight of the crystalline resin, by changing the structure or softening point of the amorphous resin, or by changing the type or melting point of the wax. Furthermore, d(log G′₂(T2))/dT can also be controlled by adding a structure with an alkyl group to the molecular chain terminal of the crystalline or amorphous resin.

Next, the raw materials for the toner will be described in detail.

The toner particle comprises a binder resin. The binder resin comprises a crystalline resin. The crystalline resin can be any known crystalline resin that can be used in toner. Specific examples include crystalline polyester resin and crystalline vinyl resin. From the viewpoint of making it easier to obtain the above-mentioned interaction, the crystalline resin preferably comprises a crystalline polyester resin, and more preferably is a crystalline polyester resin.

The crystalline polyester resin is preferably a condensation polymer of a monomer composition comprising (e.g., as the main components) an aliphatic diol (e.g., having 2 to 22 carbon atoms) and an aliphatic dicarboxylic acid (e.g., having 2 to 22 carbon atoms). The term “main component” means that the content ratio thereof is 50% by mass or more of the monomer composition. It is preferably 50 to 100% by mass, and more preferably 70 to 98% by mass.

The aliphatic diol having from 2 to 22 carbon atoms (more preferably from 2 to 12 carbon atoms) is not particularly limited, but is preferably a chain (more preferably a linear) aliphatic diol. Examples include ethylene glycol, diethylene glycol, triethylene glycol, 1,2-propanediol, 1,3-propanediol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, dodecamethylene glycol, and neopentyl glycol. Among these, 1,6-hexanediol, 1,10-decanediol, and 1,12-dodecanediol are preferred.

Polyhydric alcohol monomers other than the above aliphatic diols can also be used. Among these polyhydric alcohol monomers, examples of dihydric alcohol monomers include aromatic alcohols such as polyoxyethylenated bisphenol A and polyoxypropylenated bisphenol A; 1,4-cyclohexanedimethanol; and the like.

Furthermore, among these polyhydric alcohol monomers, it is preferable to use trihydric or higher polyhydric alcohol monomers.

Among these polyhydric alcohol monomers, trihydric or higher polyhydric alcohol monomers include aromatic alcohols such as 1,3,5-trihydroxymethylbenzene; and aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, and trimethylolpropane.

Meanwhile, the aliphatic dicarboxylic acid compound having from 2 to 22 carbon atoms (more preferably from 6 to 18 carbon atoms) is not particularly limited, but is preferably a chain (more preferably a linear) aliphatic dicarboxylic acid. Specific examples include oxalic acid, malonic acid, succinic acid, glutaric acid, adipic acid, pimelic acid, suberic acid, glutaconic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, maleic acid, fumaric acid, mesaconic acid, citraconic acid, and itaconic acid, as well as hydrolyzed lower alkyl esters and acid anhydrides thereof. More preferred examples include adipic acid, sebacic acid, and 1,10-decanedicarboxylic acid.

Polycarboxylic acids other than the above-mentioned aliphatic dicarboxylic acid compounds having from 2 to 22 carbon atoms (hereinafter referred to as “other polycarboxylic acids”) can also be used.

Among the other polycarboxylic acid monomers, examples of dicarboxylic acids include aromatic carboxylic acids such as isophthalic acid and terephthalic acid; aliphatic carboxylic acids such as n-dodecylsuccinic acid and n-dodecenylsuccinic acid; and alicyclic carboxylic acids such as cyclohexanedicarboxylic acid, as well as acid anhydrides and lower alkyl esters thereof.

Furthermore, among other carboxylic acid monomers, examples of trivalent or higher polycarboxylic acids include aromatic carboxylic acids such as 1,2,4-benzenetricarboxylic acid (trimellitic acid), 2,5,7-naphthalenetricarboxylic acid, 1,2,4-naphthalenetricarboxylic acid, and pyromellitic acid, and aliphatic carboxylic acids such as 1,2,4-butanetricarboxylic acid, 1,2,5-hexanetricarboxylic acid, and 1,3-dicarboxy-2-methyl-2-methylenecarboxypropane, as well as acid anhydrides and lower alkyl esters thereof.

In addition to the above-mentioned monomers, it is particularly preferable that the monomer composition forming the crystalline polyester resin comprises at least one selected from the group consisting of monohydric alcohols and monovalent carboxylic acids. In other words, the crystalline polyester resin preferably comprises a condensation polymer of a monomer composition comprising an aliphatic diol and an aliphatic dicarboxylic acid. The crystalline polyester resin preferably has a structure in which at least one linear alkyl compound C selected from the group consisting of monohydric alcohols and monovalent carboxylic acids is condensed at the molecular chain terminal.

By using these monohydric alcohols and/or monovalent carboxylic acids, the molecular chain terminal of the crystalline polyester resin becomes an alkyl group. During the cooling process after the toner melts, this terminal alkyl group is more likely to interact with other binder resins. As a result, the value of G′₃(70)/G′₂(70) and the absolute value of d(log G′₂(T2))/dT of the toner increase, making it easier to control the values of G′₃(50) and G′₃(70) within the above-mentioned ranges. It is particularly preferred that the linear alkyl compound C comprise a monovalent carboxylic acid.

The monohydric alcohol is preferably a monohydric alcohol having 2 to 24 carbon atoms, more preferably 16 to 24 carbon atoms, and particularly preferably 18 to 22 carbon atoms. Furthermore, aliphatic monohydric alcohols are preferred, and linear aliphatic monohydric alcohols are more preferred.

Examples of monohydric alcohols include ethanol, n-butanol, isobutanol, sec-butanol, n-hexanol, n-octanol, lauryl alcohol, cetyl alcohol, stearyl alcohol, arachidyl alcohol, behenyl alcohol, lignoceryl alcohol, 2-ethylhexanol, decanol, cyclohexanol, benzyl alcohol, and dodecyl alcohol. Of these, cetyl alcohol, stearyl alcohol, arachidyl alcohol, behenyl alcohol, and lignoceryl alcohol are preferred.

The monovalent carboxylic acid is preferably a monovalent carboxylic acid having 2 to 24 carbon atoms, more preferably 16 to 24 carbon atoms, and particularly preferably 18 to 22 carbon atoms. Furthermore, aliphatic monovalent carboxylic acids are preferred, and linear aliphatic monovalent carboxylic acids are more preferred.

Examples of monovalent carboxylic acids include monocarboxylic acids such as benzoic acid, naphthalenecarboxylic acid, salicylic acid, 4-methylbenzoic acid, 3-methylbenzoic acid, phenoxyacetic acid, biphenylcarboxylic acid, acetic acid, propionic acid, butyric acid, octanoic acid, decanoic acid, dodecanoic acid, palmitic acid, stearic acid, arachidic acid, behenic acid, and lignoceric acid. Palmitic acid, stearic acid, arachidic acid, behenic acid, and lignoceric acid are particularly preferred.

The crystalline polyester resin preferably comprises a condensation polymer of an aliphatic diol having 2 to 22 carbon atoms and an aliphatic dicarboxylic acid having 2 to 22 carbon atoms. That is, the crystalline polyester resin preferably comprises a monomer unit corresponding to an aliphatic diol having 2 to 22 carbon atoms and a monomer unit corresponding to an aliphatic dicarboxylic acid having 2 to 22 carbon atoms.

The total content ratio of the monomer unit corresponding to an aliphatic diol having 2 to 22 carbon atoms and the monomer unit corresponding to an aliphatic dicarboxylic acid having 2 to 22 carbon atoms in the crystalline polyester resin is, for example, 50 to 100% by mass, preferably 80 to 99% by mass, and more preferably 90 to 98% by mass. In terms of mol %, 90 to 99 mol % is preferred, and 95 to 98 mol % is more preferred.

Furthermore, the crystalline polyester resin is preferably a condensation polymer with a main skeleton (a structure other than the linear alkyl compound C condensed at the terminal) of an aliphatic diol having 2 to 22 carbon atoms and an aliphatic dicarboxylic acid having 2 to 22 carbon atoms.

In the crystalline polyester resin, the content ratio of the structure in which the linear alkyl compound C is condensed at the molecular chain terminal is preferably 1 to 20% by mass, more preferably 2 to 15% by mass, and even more preferably 2 to 10% by mass. In terms of mol %, it is preferably 1 to 10 mol %, and more preferably 2 to 5 mol %.

The number of carbon atoms in the aliphatic diol that constitutes the main skeleton of the crystalline polyester resin is denoted by Cal, and the number of carbon atoms in the aliphatic dicarboxylic acid that constitutes the main skeleton of the crystalline polyester resin is denoted by Cca. Furthermore, the number of carbon atoms in the linear alkyl compound C condensed at the terminal of the crystalline polyester resin is denoted by Cend. In this case, it is preferable to satisfy the relationship Cend−(Cal+Cca)≥8.

Here, when the crystalline polyester resin comprises multiple aliphatic diols or aliphatic dicarboxylic acids constituting the main skeleton thereof, the number of carbon atoms refers to the component with the largest content (by mole). If the content is the same, the number of carbon atoms refers to the component with the largest number of carbon atoms. The same applies to the number of carbon atoms in the linear alkyl compound C condensed at the terminal.

When Cend−(Cal+Cca) is 8 or greater, this means that the total number of carbon atoms in the aliphatic diols or aliphatic dicarboxylic acids constituting the main skeleton is smaller than the number of terminal carbon atoms. Satisfying this relationship facilitates better crystallization of the crystalline polyester component constituting the main skeleton during cooling, and facilitates greater interaction between the terminal alkyl groups and other binder resins. As a result, the value of G′₃(70)/G′₂(70) and the absolute value of d(log G′₂(T2))/dT tend to increase, making it easier to control them within the aforementioned ranges, which is preferable.

Cend−(Cal+Cca) is, for example, 2 to 14, preferably 8 to 14, more preferably 8 to 12, and even more preferably 8 to 10.

The melting point Tc of the crystalline resin (preferably a crystalline polyester resin) is preferably 70 to 100° C., more preferably 80 to 100° C., even more preferably 80 to 95° C., and still more preferably 80 to 90° C.

The weight-average molecular weight Mwc of the THF-soluble fraction of the crystalline resin (preferably a crystalline polyester resin) is preferably 10,000 to 100,000, more preferably 16,000 to 100,000, even more preferably 18,000 to 50,000, and still more preferably 18,000 to 30,000.

Crystalline polyester resins can be produced according to usual polyester synthesis methods. For example, the desired crystalline polyester resin can be obtained by subjecting the aforementioned carboxylic acid monomer and alcohol monomer to an esterification reaction or transesterification reaction, followed by a condensation polymerization reaction carried out according to a conventional method under reduced pressure or by introducing nitrogen gas.

The esterification or transesterification reaction can be carried out by using, as necessary, a conventional esterification catalyst or transesterification catalyst, such as sulfuric acid, titanium butoxide, dibutyltin oxide, manganese acetate, or magnesium acetate.

The condensation polymerization reaction can also be carried out using a well-known polymerization catalyst, such as titanium butoxide, dibutyltin oxide, tin acetate, zinc acetate, tin disulfide, antimony trioxide, or germanium dioxide. The polymerization temperature and catalyst amount are not particularly limited and can be determined as appropriate.

In the esterification or transesterification reaction or condensation polymerization reaction, all monomers may be charged at once to increase the strength of the resulting crystalline polyester resin, or a method may be used in which a divalent monomer is reacted first, and then a trivalent or higher monomer is added and reacted to reduce the amount of low-molecular-weight components.

From the viewpoint of achieving low-temperature fixability, suppression of image defects during double-sided printing, and charging stability, the content of the crystalline resin (preferably a crystalline polyester resin) in the toner is preferably 1 to 30% by mass, based on the mass of the toner. This content is more preferably 3 to 20% by mass, and even more preferably 5 to 15% by mass.

Crystalline polyester resins may be used alone or in combination.

In addition to the above-mentioned crystalline resins, the binder resin may also comprise other binder resins.

It is preferable that the binder resin comprises an amorphous resin. When an amorphous resin is further comprised as the binder resin, known amorphous resins can be used.

Examples of amorphous resins include the following.

Polyvinyl chloride, phenolic resin, natural resin-modified phenolic resin, natural resin-modified maleic acid resin, polyvinyl acetate, silicone resin, polyester resin, polyurethane resin, polyamide resin, furan resin, epoxy resin, xylene resin, polyvinyl butyral, terpene resin, coumarone-indene resin, petroleum-based resin, and vinyl resin.

Among these, it is preferable to comprise at least one resin selected from the group consisting of a hybrid resin in which a vinyl resin and a polyester resin are bonded, a polyester resin, and a vinyl resin.

An amorphous polyester resin is even more preferred. That is, it is preferable that the binder resin comprises an amorphous polyester resin. The use of an amorphous polyester resin makes the above-mentioned interaction with the crystalline polyester resin more likely to occur. This makes it easier to control the values of G′₃(70)/G′₂(70), G′₃(50), and G′₃(70) within the above-mentioned ranges.

Polyester resins typically used in toners can be suitably used as the amorphous polyester resin. Examples of monomers used in such polyester resins include polyhydric alcohols (dihydric, trihydric, or higher alcohols), polycarboxylic acids (divalent, trivalent, or higher carboxylic acids), anhydrides thereof, or lower alkyl esters thereof.

The amorphous polyester resin is preferably a condensation polymer of a carboxylic acid and an alcohol with a polyhydric alcohol having an aromatic ring as the main component. Regarding the polyhydric alcohol having an aromatic ring, the content of the aromatic diol in the total alcohol constituting the amorphous polyester resin is preferably 50 to 100% by mass, or 80 to 99% by mass. In other words, the content of the monomer units corresponding to the aromatic diol among the monomer units corresponding to the total alcohol constituting the amorphous polyester resin is preferably 50 to 100% by mass, or 80 to 99% by mass. In terms of mol %, 50 to 100 mol % is preferred, and 80 to 99 mol % is more preferred.

Examples of such polyhydric alcohols include the following.

Examples of dihydric alcohols having an aromatic ring include the following bisphenol derivatives.

Polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, polyoxypropylene (6)-2,2-bis(4-hydroxyphenyl)propane, etc.

Examples of other polyhydric alcohols include ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, trimethylolpropane, and 1,3,5-trihydroxymethylbenzene.

These polyhydric alcohols can be used alone or in combination.

Examples of the polycarboxylic acids include the following.

Examples of dicarboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, anhydrides of these acids, and lower alkyl esters of these acids. Of these, maleic acid, fumaric acid, terephthalic acid, n-dodecenylsuccinic acid, and adipic acid are preferably used.

Examples of trivalent or higher carboxylic acids, anhydrides thereof, and lower alkyl esters thereof include the following.

1,2,4-Benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxy)methane, 1,2,7,8-octanetetracarboxylic acid, pyromellitic acid, Empol trimer acid, anhydrides thereof, and lower alkyl esters thereof.

Of these, 1,2,4-benzenetricarboxylic acid (trimellitic acid) or derivatives thereof, such as anhydride thereof, is preferred due to low cost thereof and ease of reaction control.

These polyvalent carboxylic acids can be used alone or in combination.

The polycarboxylic acid of the amorphous polyester resin preferably comprises a monomer unit corresponding to a linear aliphatic dicarboxylic acid.

When the amorphous polyester resin comprises a monomer unit corresponding to a linear aliphatic dicarboxylic acid, interaction with the alkyl group at the molecular chain terminal of the crystalline polyester resin is further facilitated. This makes it easier to control the values of G′₃(70)/G′₂(70), G′₃(50), and G′₃(70) within the above-mentioned ranges.

Among these, linear aliphatic dicarboxylic acids having 4 to 12 carbon atoms are preferred. Examples thereof include succinic acid, glutaric acid, adipic acid, pimelic acid, suberic acid, azelaic acid, sebacic acid, and dodecanedioic acid.

The content of the monomer unit corresponding to a linear aliphatic dicarboxylic acid in the total of carboxylic acids constituting the amorphous polyester is preferably 1 to 50 mol %. This content is more preferably 10 to 50 mol %, and even more preferably 15 to 40 mol %. In terms of % by mass, 1 to 20% by mass and 3 to 15% by mass are preferred.

Furthermore, the amorphous polyester resin preferably has a molecular chain terminal condensed with at least one linear alkyl compound A selected from the group consisting of aliphatic linear monocarboxylic acids (e.g., having 6 to 24 carbon atoms) and aliphatic linear monoalcohols (e.g., having 6 to 24 carbon atoms).

Where a carboxy group is present at the molecular chain terminal of the amorphous polyester resin before condensation with the monomer having from 6 to 24 carbon atoms, a condensation reaction with the linear alkyl monoalcohol occurs.

Where a hydroxy group is present at the molecular chain terminal of the amorphous polyester resin before condensation with the monomer having from 6 to 24 carbon atoms, a condensation reaction with the linear alkyl monocarboxylic acid occurs.

Where the amorphous polyester resin has, at the molecular chain terminal, a structure formed by condensation of one or more monomers selected from the group consisting of aliphatic linear monocarboxylic acids having from 6 to 24 carbon atoms and aliphatic linear monoalcohols having from 6 to 24 carbon atoms, this structure is more likely to interact with the alkyl group at the terminal of the crystalline polyester resin.

As a result, the interaction between the crystalline polyester resin and the amorphous polyester resin is strengthened during the cooling process after melting. This makes it easier to control the values of G′₃(70)/G′₂(70), G′₃(50), and G′₃(70) within the above-mentioned ranges. This results in improved fixed image strength after the toner solidifies and further enhances the effect of suppressing image defects during double-sided printing, which is preferable.

Examples of aliphatic linear monocarboxylic acids having from 6 to 24 carbon atoms include hexanoic acid, heptanoic acid, octanoic acid, nonanoic acid, decanoic acid, dodecanoic acid, tetradecanoic acid, hexadecanoic acid, stearic acid, arachidic acid, behenic acid, and lignoceric acid.

Examples of aliphatic linear monoalcohols having from 6 to 24 carbon atoms include n-hexanol, n-octanol, lauryl alcohol, cetyl alcohol, stearyl alcohol, arachidyl alcohol, behenyl alcohol, and lignoceryl alcohol.

More preferred is at least one compound selected from the group consisting of linear alkyl monocarboxylic acids having from 16 to 24 carbon atoms and linear aliphatic monoalcohols having 16 to 24 carbon atoms. It is preferable that the linear alkyl compound A comprises an aliphatic linear monocarboxylic acid. Particularly preferred are aliphatic linear monocarboxylic acids having 16 to 24 carbon atoms, and among them, linear aliphatic monocarboxylic acids having 18 to 24 carbon atoms are preferred.

The amorphous polyester resin in which the above-mentioned linear alkyl compound A is condensed is referred to as amorphous polyester resin A. The binder resin preferably comprises amorphous polyester resin A.

In amorphous polyester resin A, the content ratio of the structure in which linear alkyl compound A is condensed at the molecular chain terminal is preferably 0.5 to 15% by mass, more preferably 1 to 10% by mass, and even more preferably 1 to 5% by mass. In terms of mol %, the content ratio is preferably 1 to 15 mol %, more preferably 2 to 10 mol %.

The number of carbon atoms in linear alkyl compound A at the molecular chain terminal of the amorphous polyester is denoted by Aend. Furthermore, the number of carbon atoms in linear alkyl compound C at the molecular chain terminal of the crystalline polyester resin is denoted by Cend. In this case, it is preferable that the following relationships be satisfied.

$$Cend \geq 16$$

$$- 4 \leq Cend - Aend \leq 6$$

When Cend−Aend satisfies the above relationship, it means that the numbers of carbon atoms at the molecular chain terminals of the crystalline polyester resin and the amorphous polyester resin are close to each other. As a result, the aforementioned interaction between the alkyl groups at the terminals of the crystalline polyester resin and the amorphous polyester resin is more effective, which is preferable. This makes it easier to control the values of G′₃(70)/G′₂(70), G′₃(50), G′₃(70), and d(log G′₂(T2))/dT within the above-mentioned ranges.

Cend−Aend may be, for example, −4 to 22, and more preferably −2 to 4.

Cend is more preferably 16 to 24, and even more preferably 18 to 22.

Furthermore, it is preferable that Aend satisfy the condition Aend≥16. Aend is, for example, 6 to 26, preferably 16 to 24, and more preferably 16 to 22.

For Cend and Aend, if there are multiple linear alkyl compounds C, each carbon number refers to the carbon number of the component with the highest content (by mole); if the contents are the same, the carbon number refers to the component with the largest carbon number.

There are no particular restrictions on the method for producing polyester resin, and known methods can be used. For example, the aforementioned polyhydric alcohol and polycarboxylic acid are simultaneously charged and polymerized via an esterification reaction or a transesterification reaction and a condensation reaction to produce a polyester resin. The polymerization temperature is also not particularly limited, but is preferably in the range from 180 to 290° C. Polymerization catalysts such as titanium-based catalysts, tin-based catalysts, zinc acetate, antimony trioxide, and germanium dioxide can be used in the polymerization of polyester resin.

The polyester resin is preferably one that has been produced by condensation polymerization using at least one of a titanium-based catalyst and a tin-based catalyst.

The softening point Tm of amorphous polyester resin A is preferably 80 to 150° C., or 85 to 105° C.

The weight-average molecular weight Mwa of the THF-soluble fraction of amorphous polyester resin A is preferably 3000 to 1,000,000, 3000 to 20,000, or 4000 to 8000.

A single amorphous resin or multiple amorphous resins can be used.

In order to easily control G′₁(100), G′₃(50), and G′₃(70) of the toner within the above-mentioned ranges, it is preferable to use multiple amorphous polyesters with softening points that differ by 20 to 60° C. It is even more preferable to use multiple amorphous polyesters with softening points that differ by 35 to 60° C.

The amorphous resin preferably comprises, in addition to amorphous polyester resin A, an amorphous polyester resin B different from amorphous polyester resin A. The softening point Tm of amorphous polyester resin B is preferably 20 to 60° C. higher, and more preferably 35 to 60° C. higher, than the softening point Tm of amorphous polyester resin A.

The mass ratio of the low-softening-point amorphous polyester resin A to the high-softening-point amorphous polyester resin B is preferably 30/70 to 90/10, and more preferably 50/50 to 80/20.

Amorphous polyester resin B can be a condensation polymer of a carboxylic acid and an alcohol other than the monoalcohol and monocarboxylic acid in amorphous polyester resin A described above.

The alcohol preferably comprises an aromatic diol. The content of aromatic diol in the total alcohol constituting amorphous polyester resin B is preferably 80 to 100 mol %, more preferably 90 to 100 mol %. Furthermore, in terms of % by mass, it is preferably 80 to 100% by mass, more preferably 90 to 100% by mass.

The carboxylic acid is preferably at least one selected from the group consisting of adipic acid, maleic acid, fumaric acid, and terephthalic acid. Amorphous polyester resin B is preferably crosslinked with a trivalent carboxylic acid such as trimellitic acid or trimellitic anhydride.

The glass transition temperature (TgB) of amorphous polyester resin B measured with a differential scanning calorimeter is preferably from 50.0 to 70.0° C., and more preferably from 54.0 to 60.0° C.

The weight-average molecular weight Mwb of amorphous polyester resin B is preferably 20,000 to 300,000, 50,000 to 200,000, or 80,000 to 150,000.

The softening point Tm of amorphous polyester resin B is preferably 120 to 170° C., and more preferably 130 to 160° C.

The content ratio of amorphous polyester resin A in the amorphous resin is, for example, 50.0 to 95.0% by mass, or 60.0 to 80.0% by mass.

The content ratio of amorphous polyester resin B in the amorphous resin is, for example, 5.0 to 50.0% by mass, or 20.0 to 40.0% by mass.

The content ratio of amorphous polyester resin A, based on the mass of the toner particle, can be, for example, 20.0 to 80.0% by mass, 30.0 to 70.0% by mass, or 40.0 to 60.0% by mass.

The content of amorphous polyester resin B, based on the mass of the toner particle, can be, for example, 5.0 to 45.0% by mass, 10.0 to 35.0% by mass, or 17.0 to 28.0% by mass.

Furthermore, when the amorphous polyester resin comprises amorphous polyester resin A having a structure in which the above-mentioned linear alkyl compound A is condensed at the molecular chain terminal, it is preferable that the following be satisfied. That is, the weight-average molecular weight of the THF-soluble fraction of the amorphous polyester resin A is denoted by Mwa, and the weight-average molecular weight of the THF-soluble fraction of the crystalline polyester resin is denoted by Mwc. In this case, Mwa/Mwc is, for example, 0.65 or less, and it is preferable that the relationship Mwa/Mwc≤0.50 be satisfied.

It is preferable that the ratio Mwa/Mwc satisfies the above relationship because charging stability during durability printing is improved, although the mechanism is unclear. More preferably, Mwa/Mwc is ≤0.4. Mwa/Mwc is preferably 0.10 to 0.50, and more preferably 0.20 to 0.40.

The binder resin may comprise a vinyl resin. Examples of vinyl resins that can be used as binder resins include polymers of vinyl monomers comprising ethylenically unsaturated bonds. An ethylenically unsaturated bond refers to a carbon-carbon double bond capable of radical polymerization, and examples thereof include a vinyl group, a propenyl group, an acryloyl group, and a methacryloyl group.

Examples of vinyl monomers are listed below.

Styrene and styrene-based monomers such as o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene;
acrylic acid; and acrylic acid esters such as methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, and phenyl acrylate;
methacrylic acid; and methacrylic acid esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; and also
acrylonitrile, methacrylonitrile, acrylamide, etc.

Other examples include acrylic acid esters and methacrylic acid esters such as 2-hydroxyethyl acrylate, 2-hydroxyethyl methacrylate, and 2-hydroxypropyl methacrylate, and polymerizable monomers having a hydroxy group such as 4-(1-hydroxy-1-methylbutyl)styrene and 4-(1-hydroxy-1-methylhexyl)styrene. These can be used alone or in combination.

Among these, it is preferable to use monomers that are condensates of acrylic acid or methacrylic acid with alcohols having 6 to 22 carbon atoms, such as n-octyl acrylate, dodecyl acrylate, 2-ethylhexyl acrylate, stearyl acrylate, n-octyl methacrylate, dodecyl methacrylate, 2-ethylhexyl methacrylate, and stearyl methacrylate.

In addition to the above, various polymerizable monomers capable of vinyl polymerization may be used in combination with the vinyl resin as needed.

Examples of such polymerizable monomers are listed hereinbelow.

Unsaturated monoolefins such as ethylene, propylene, butylene, and isobutylene; unsaturated polyenes such as butadiene and isoprene; vinyl halides such as vinyl chloride, vinylidene chloride, vinyl bromide, and vinyl fluoride; vinyl esters such as vinyl acetate, vinyl propionate, and vinyl benzoate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinylnaphthalenes; unsaturated dibasic acids such as maleic acid, citraconic acid, itaconic acid, alkenylsuccinic acid, fumaric acid, and mesaconic acid; unsaturated dibasic acid anhydrides such maleic anhydride, citraconic anhydride, itaconic anhydride, and alkenylsuccinic anhydride; half esters of unsaturated basic acids such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half ester, methyl fumarate half ester, and methyl mesaconate half ester; unsaturated basic acid esters such as dimethylmaleic acid and dimethylfumaric acid; acid anhydrides of α,β-unsaturated acids such as acrylic acid, methacrylic acid, crotonic acid, and cinnamic acid; anhydrides of such α,β-unsaturated acids and lower fatty acids; and polymerizable monomers having a carboxy group such as alkenylmalonic acid, alkenylglutaric acid, alkenyladipic acid, anhydrides thereof and monoesters thereof.

Furthermore, if necessary, the vinyl resin may be a polymer crosslinked with a crosslinkable polymerizable monomer, such as those exemplified below.

Examples of such crosslinkable polymerizable monomers include the following monomers.

Aromatic divinyl compounds; diacrylate compounds bonded by alkyl chains; diacrylate compounds bonded by alkyl chains comprising ether bonds; diacrylate compounds bonded by aromatic groups and chains comprising ether bonds; polyester-type diacrylates; and polyfunctional crosslinking agents.

Examples of such aromatic divinyl compounds include divinylbenzene and divinylnaphthalene.

Examples of diacrylate compounds bonded by alkyl chains include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and compounds in which the acrylate in the above compounds is replaced with methacrylate.

The vinyl resin may also be a copolymer of monomers including at least one polymerizable monomer selected from the vinyl monomers listed above and at least one crosslinkable polymerizable monomer selected from the group consisting of divinylbenzene, divinylnaphthalene, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, ethylene glycol dimethacrylate, 1,3-butylene glycol dimethacrylate, 1,4-butanediol dimethacrylate, 1,5-pentanediol dimethacrylate, 1,6-hexanediol dimethacrylate, and neopentyl glycol dimethacrylate. The content ratio of the crosslinkable polymerizable monomer in the monomers may be approximately 0.5 to 5.0% by mass.

The vinyl resin may also be a resin produced using a polymerization initiator. From the viewpoint of efficiency, the polymerization initiator should be used in an amount of from 0.05 to 10.00 parts by mass per 100.00 parts by mass of the polymerizable monomers. Examples of such polymerization initiators are listed hereinbelow.

2,2′-Azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), ketone peroxides such as methyl ethyl ketone peroxide, acetylacetone peroxide, and cyclohexanone peroxide, 2,2-bis(tert-butylperoxy)butane, tert-butyl hydroperoxide, cumene hydroperoxide, 1,1,3,3-tetramethylbutyl hydroperoxide, di-tert-butyl peroxide, tert-butylcumyl peroxide, dicumyl peroxide, α,α′-bis(tert-butylperoxyisopropyl)benzene, isobutyl peroxide, and octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexylsulfonyl peroxide, tert-butylperoxyacetate tert-butylperoxyisobutyrate, tert-butylperoxyneodecanoate, tert-butylperoxy-2-ethylhexanoate, tert-butylperoxylaurate, tert-butylperoxybenzoate, tert-butylperoxyisopropylcarbonate, di-tert-butylperoxyisophthalate, tert-butylperoxyallylcarbonate, tert-amylperoxy-2-ethylhexanoate, di-tert-butylperoxyhexahydroterephthalate, and di-tert-butylperoxyazelate.

The vinyl resin and polyester resin used to form the hybrid resin in which the vinyl resin and polyester resin are bonded can be the same as the vinyl resin and polyester resin used as the amorphous resin described above.

A hybrid resin composed of a vinyl resin and a polyester resin can be obtained, for example, by polymerization using a compound that can react with monomers producing both resins (hereinafter referred to as a “bireactive compound”).

Examples of bireactive compounds include fumaric acid, acrylic acid, methacrylic acid, citraconic acid, maleic acid, and dimethyl fumarate. Of these, fumaric acid, acrylic acid, and methacrylic acid are preferred.

When using a hybrid resin composed of a vinyl resin and a polyester resin, the content ratio of vinyl resin in the hybrid resin is preferably 10% by mass or more, 20% by mass or more, 40% by mass or more, 60% by mass or more, or 80% by mass or more, and preferably 100% by mass or less or 90% by mass or less.

Furthermore, the binder resin can also comprise a polymer having a structure resulting from the reaction of a vinyl resin component with a hydrocarbon compound. Among these, the binder resin preferably comprises a graft polymer formed by graft polymerization of a vinyl monomer onto a polyolefin. The vinyl monomer preferably comprises styrene, (meth)acrylonitrile, and at least one selected from the group consisting of acrylic acid esters. The binder resin may also comprise a graft polymer formed by grafting a styrene-acrylic resin onto a polyolefin.

When the binder resin comprises such a graft polymer, compatibility between the wax and the resin is promoted, making it easier to suppress poor charging and component contamination due to poor wax dispersion. The content of the graft polymer formed by graft polymerization of a vinyl monomer onto a polyolefin is preferably 1.0 to 15.0% by mass, based on the mass of the toner, and more preferably 2.0 to 10.0% by mass.

The content within the above range facilitates uniform dispersion of the wax within the binder resin. The polyolefin is not particularly limited as long as it is a polymer or copolymer of an unsaturated hydrocarbon, and various polyolefins can be used. Polyethylene-based and polypropylene-based polyolefins are particularly preferred. Multiple polyolefins may also be used.

The vinyl monomer may be selected from the monomers that can be used for the vinyl resin described above.

Graft polymers in which vinyl monomers are graft-polymerized onto polyolefins can be obtained by known methods, such as the aforementioned reactions between these polymers or the reactions between the monomers of one polymer and the monomers of another polymer.

### Other Resins

The binder resin may comprise resins other than those listed above, to the extent that the effects of the present disclosure are not impaired, for purposes such as improving pigment dispersibility.

Examples of such resins are listed hereinbelow.

Polyvinyl chloride, phenolic resin, natural resin-modified phenolic resin, natural resin-modified maleic acid resin, polyvinyl acetate, silicone resin, polyester resin, polyurethane resin, polyamide resin, furan resin, epoxy resin, xylene resin, polyvinyl butyral, terpene resin, coumarone-indene resin, and petroleum-based resin.

The content of the binder resin is preferably 70 to 98% by mass, and more preferably 80 to 95% by mass, based on the mass of the toner.

### Wax

The toner particle comprises wax. The wax may be selected to be optimal for use in combination with the crystalline resin. Examples of waxes are listed hereinbelow.

Hydrocarbon waxes such as microcrystalline wax, paraffin waxes, and Fischer-Tropsch waxes; oxides of hydrocarbon waxes or their block copolymers such as oxidized polyethylene wax; waxes with fatty acid esters such as carnauba wax a main component; and partially or fully deoxidized fatty acid esters such as deoxidized carnauba wax.

Further examples are listed hereinbelow. Saturated linear fatty acids such as palmitic acid, stearic acid, and montanic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyhydric alcohols such as sorbitol; esters of fatty acids such as palmitic acid, stearic acid, behenic acid, and montanic acid with alcohols such as stearyl alcohol, aralkyl alcohol, behenyl alcohol, carnaubyl alcohol, ceryl alcohol, and melissyl alcohol; fatty acid amides such as linoleic acid amide, oleic acid amide, and lauric acid amide; saturated fatty acid bisamides such as methylenebis(stearamide), ethylenebis(capramide), ethylenebis(lauramide), and hexamethylenebis(stearamide); unsaturated fatty acid amides such as ethylenebis(oleamide), hexamethylenebis(oleamide), N,N′-dioleyl adipamide, and N,N′-dioleyl sebacate; aromatic bisamides such as m-xylenebis(stearamide) and N,N′-distearylisophthalamide; fatty acid metal salts (commonly known as metal soaps) such as calcium stearate, calcium laurate, zinc stearate, and magnesium stearate; waxes obtained by grafting aliphatic hydrocarbon waxes with vinyl monomers such as styrene and acrylic acid; partial esters of fatty acids and polyhydric alcohols such as behenic acid monoglyceride; and methyl ester compounds having hydroxy groups obtained by hydrogenating vegetable oils and fats.

The wax preferably comprises at least one selected from the group consisting of ester waxes and hydrocarbon waxes, more preferably hydrocarbon waxes, and even more preferably Fischer-Tropsch waxes. The melting point of the wax is preferably 75 to 120° C., more preferably 84 to 120° C., and even more preferably 88 to 110° C. It is more preferable that the difference between the melting point Tc of the crystalline resin and the melting point of the wax be within 10° C.

When the wax comprises hydrocarbon wax, the hydrocarbon wax, together with the crystalline resin, is more likely to interact with the binder resin as described above during cooling after melting. The increase in storage elastic modulus during cooling is more gradual than when the wax does not comprise hydrocarbon wax, making it easier to control the G′₃(70)/G′₂(70) value higher.

Furthermore, the number of carbon atoms corresponding to a peak detected as a maximum peak when the wax is analyzed by gas chromatography-mass spectrometry (GC/MS) is denoted by Wmax. In this case, Wmax-Aend is, for example, 12 to 42, and it is preferable that Wmax and Aend satisfy the relationships Aend≥16 and 16≤Wmax−Aend≤30.

Where Wmax−Aend is within this range, it is easier to increase the value of G′₃(70), and image defects during double-sided printing can be suppressed more effectively. This is thought to be because the crystalline polyester resin is more likely to move during the cooling process after melting, resulting in a larger G′₃(70).

More preferably, 20≤Wmax−Aend≤30, and even more preferably, 20≤Wmax−Aend≤25.

The wax content, based on the mass of the toner, is preferably 2.0 to 30.0% by mass, more preferably 4.0 to 20.0% by mass, and even more preferably 4.0 to 10.0% by mass.

### Inorganic Filler Particles

The toner particle may comprise inorganic filler particles as needed, for example, for adjusting viscoelasticity.

Preferred inorganic filler particles include silica, titanium oxide, aluminum oxide, metal titanates such as strontium titanate and calcium titanate, calcium carbonate, and kaolin.

The inorganic filler particles are preferably treated with a fatty acid. Surface-treating the filler particles with a fatty acid is preferred because it allows the filler effect to be more effectively exhibited due to interaction with the alkyl groups of the crystalline resin via the fatty acid.

The number-average diameter of primary particles of the inorganic filler particles incorporated into the toner particle is preferably 0.15 to 0.45 m, and more preferably 0.20 to 0.40 m. The number-average diameter of primary particles of the inorganic filler particles can be measured using known means such as a scanning electron microscope.

The content ratio of inorganic filler particles based on the mass of the toner particle is preferably 0 to 20% by mass, and more preferably 0 to 7% by mass.

### Colorant

The toner particle may optionally comprise a colorant. Examples of colorants are listed hereinbelow.

Black colorants include carbon black; and those toned to black using yellow, magenta, and cyan colorants. While pigments may be used alone for a colorant, using a combination of dyes and pigments to improve the clarity of full-color images is preferable in terms of image quality.

Pigments for magenta toners can be exemplified by the following:

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C. I. Pigment Violet 19; and C. I. Vat Red 1, 2, 10, 13, 15, 23, 29, and 35.

Dyes for magenta toners can be exemplified by the following: oil-soluble dyes such as C. I. Solvent Red 1, 3, 8, 23, 24, 25, 27, 30, 49, 81, 82, 83, 84, 100, 109, and 121; C. I. Disperse Red 9; C. I. Solvent Violet 8, 13, 14, 21, and 27; and C. I. Disperse Violet 1, and basic dyes such as C. I. Basic Red 1, 2, 9, 12, 13, 14, 15, 17, 18, 22, 23, 24, 27, 29, 32, 34, 35, 36, 37, 38, 39, and 40 and C. I. Basic Violet 1, 3, 7, 10, 14, 15, 21, 25, 26, 27, and 28.

Pigments for cyan toners can be exemplified by the following: C. I. Pigment Blue 2, 3, 15:2, 15:3, 15:4, 16, and 17; C. I. Vat Blue 6; C. I. Acid Blue 45; and copper phthalocyanine pigments having at least 1 and not more than 5 phthalimidomethyl groups substituted on the phthalocyanine skeleton. C. I. Solvent Blue 70 is an example of a dye for cyan toners.

Pigments for yellow toners can be exemplified by the following: C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185 and by C. I. Vat Yellow 1, 3, and 20. C. I. Solvent Yellow 162 is an example of a dye for yellow toners.

These colorants may be used alone, in mixtures, or even in the form of a solid solution. Colorants are selected based on hue angle, chroma, lightness, lightfastness, OHP transparency, and dispersibility in the toner.

The colorant content is preferably 0.1 to 30.0 parts by mass per 100 parts by mass of binder resin.

### Charge Control Agent

The toner particle may optionally comprise a charge control agent. While known charge control agents can be used, metal compounds of aromatic carboxylic acids are particularly preferred because they are colorless, provide fast toner charging, and can stably maintain a constant charge level.

Negative charge control agents include metal salicylate compounds, metal naphthoate compounds, metal dicarboxylic acid compounds, polymeric compounds having a sulfonic acid or carboxylic acid group in a side chain, polymeric compounds having a sulfonic acid salt or sulfonic acid ester in a side chain, polymeric compounds having a carboxylic acid salt or carboxylic acid ester in a side chain, boron compounds, urea compounds, silicon compounds, and calixarenes.

The charge control agent may be added internally or externally to the toner particle. The content of the charge control agent is preferably 0.2 to 10.0 parts by mass, and more preferably 0.5 to 10.0 parts by mass, per 100 parts by mass of the binder resin.

### External Additive

The toner may comprise an external additive. For example, the toner may be produced by adding an external additives to a toner particle. Preferred external additives are inorganic fine particles such as silica, titanium oxide, aluminum oxide, and metal titanates. The inorganic fine particles used as external additives are preferably hydrophobized with a hydrophobizing agent such as a silane compound, silicone oil, or a mixture thereof.

To improve fluidity, inorganic fine particles with a BET specific surface area of 50 to 400 m²/g are preferred. To stabilize durability, inorganic fine particles with a BET specific surface area of 10 to 50 m²/g are preferred. To achieve both improved fluidity and stabilized durability, inorganic fine particles with a BET specific surface area within the above ranges may be used in combination. To mix the toner particle and external additives, a known mixer such as a Henschel mixer can be used.

The content ratio of the external additive is preferably 0.1 to 10.0 parts by mass, and more preferably 2.0 to 7.0 parts by mass, per 100 parts by mass of toner particle.

### Developer

While toner can be used as a one-component developer, mixing it with a magnetic carrier to create a two-component developer is preferable because it produces stable images over a long period of time. In other words, a two-component developer comprising toner and a magnetic carrier, in which the toner is the toner described above, is more preferred.

Examples of magnetic carriers include commonly known carriers such as iron powder or surface-oxidized iron powder; metal particles such as iron, lithium, calcium, magnesium, nickel, copper, zinc, cobalt, manganese, chromium, and rare earth elements, alloy particles thereof, or oxide particles thereof, magnetic materials such as ferrite; and magnetic-material-dispersed resin carriers (so-called resin carriers) comprising the magnetic material and a binder resin that holds the magnetic material in a dispersed state.

When toner is mixed with a magnetic carrier to create a two-component developer, the content ratio of toner in the two-component developer is preferably from 2.0 to 15.0% by mass, and more preferably from 4.0 to 13.0% by mass.

### Method for Producing Toner

There are no particular limitations on a method for producing toner, and conventional production methods such as suspension polymerization, emulsion aggregation, melt-kneading, and dissolution suspension can be used.

The procedure for producing toner using the melt-kneading pulverization method is described below.

### Raw Material Mixing Step

In the raw material mixing step, the materials that will make up the toner particle, such as a binder resin comprising a crystalline resin and, if necessary, an amorphous resin, wax, and, if necessary, other components such as a colorant and a charge control agent, are weighed out in predetermined amounts, blended, and mixed. Examples of mixing equipment include a double-cone mixer, V-type mixer, drum mixer, Super mixer, Henschel mixer, Nauta mixer, and Mechano Hybrid (manufactured by Nippon Coke and Engineering Co., Ltd.).

### Melting and Kneading Step

Next, the mixed materials are melt-kneaded to disperse the wax and other components in the binder resin. In the melt-kneading process, batch kneaders such as pressure kneaders and Banbury mixers, as well as continuous kneaders, can be used. Single-screw or twin-screw extruders are commonly used due to their advantage of continuous production. Examples include KTK twin-screw extruder (manufactured by Kobe Steel, Ltd.), TEM twin-screw extruder (manufactured by Toshiba Machine Co., Ltd.), PCM kneader (manufactured by Ikegai Iron Works Co., Ltd.), a twin-screw extruder (KCK Corporation), Co-Kneader (manufactured by Buss AG), and Kneedex (manufactured by Nippon Coke and Engineering Co., Ltd.). Furthermore, the resin composition obtained by melt-kneading may be rolled using a twin-roll mill or the like and cooled with water or the like in a cooling step.

In the melt-kneading step, melt-kneading is preferably performed using a twin-screw extruder.

The kneading temperature is preferably 110 to 160° C., more preferably 110 to 150° C. The screw rotation speed during kneading can be changed, as appropriate, depending on the equipment used, but is not particularly limited; for example, 200 to 300 rpm is preferred.

### Cooling Step

The procedure of cooling step is not particularly limited. Examples of suitable methods include rolling the kneaded resin composition between two rollers or drums, followed by cooling with a steel belt cooler (manufactured by Nippon Steel Conveyor Co., Ltd.), or rolling while cooling with a press roller and a drum equipped with an internal cooling mechanism, such as a belt drum flaker (manufactured by Nippon Coke and Engineering Co., Ltd.). In the cooling step, rolling while cooling with a belt drum flaker is preferred.

### Pulverizing Step

The cooled resin composition is then pulverized to the desired particle diameter in the pulverizing step. In the pulverizing step, the material is coarsely pulverized using a pulverizer such as a crusher, hammer mill, or feather mill, and then finely pulverized using a fine pulverizer using Cryptron System (manufactured by Kawasaki Heavy Industries Co., Ltd.), Super Rotor (manufactured by Nisshin Engineering Co., Ltd.), Turbo Mill (manufactured by Turbo Kogyo Co., Ltd.), or an air jet system.

### Classification Step

If necessary, classification can be then performed using a classifier or sieve such Elbow Jet of an inertial classification system (manufactured by Nitetsu Mining Co., Ltd.), Turboplex of a centrifugal classification system (manufactured by Hosokawa Micron Corporation), TSP Separator (manufactured by Hosokawa Micron Corporation), or Faculty (manufactured by Hosokawa Micron Corporation) to obtain toner particle.

### External Addition Step

The resulting toner particle may be used as they are. Toner may also be obtained by externally adding an external additive to the surface of the toner particle. Examples of methods for adding external additives include blending the classified toner with a predetermined amount of various known external additives, and stirring and mixing them by using a mixer such as a double-cone mixer, V-type mixer, drum mixer, Super mixer, Henschel mixer, Nauta mixer, Mechano Hybrid (manufactured by Nippon Coke and Engineering Co., Ltd.), or Nobilta (manufactured by Hosokawa Micron Corporation) as an external addition device.

### Annealing Step

In toner production, the melt-kneaded product obtained after the melt-kneading step is preferably annealed by holding at a temperature that is higher than the melting point of the crystalline resin by 5° C. or more for 10 min or more. Annealing may be performed after the melt-kneading and cooling steps, but is preferably performed before the cooling step.

Methods for measuring various physical properties of toner and raw materials are described below.

### <Measuring Storage Elastic Modulus G′ by Measuring Toner Viscoelasticity>

The measurement device used is a rotating plate rheometer “ARES” (manufactured by TA Instruments). The measurement sample is prepared by press-molding (20 MPa for 30 sec) toner into a disk shape with a diameter of 8 mm and a thickness of 2.0±0.3 mm using a tablet press in an environment at 25° C.

The sample is mounted on a parallel plate and the temperature is raised from room temperature (25° C.) to 80° C. over 15 min to reshape the sample. After cooling to the viscoelasticity measurement starting temperature, the measurement is started and the complex viscosity is measured. In this case, the sample is set so that the initial normal force is zero. Furthermore, as described below, the influence of normal force can be canceled out in subsequent measurements by turning on the automatic tension adjustment (Auto Tension Adjustment ON).

Measurements were performed under the following conditions.
(1) A parallel plate with a diameter of 8 mm is used.
(2) The frequency (Frequency) is set to 6.28 rad/sec (1.0 Hz).
(3) The initial applied strain (Strain) is set to 0.01%.
(4) The measurement interval (Steptime) is set to 15 sec.

The measurement is performed under the set conditions of the following automatic adjustment mode settings. Thus, the measurement is performed the in automatic strain adjustment mode (Auto Strain).
(5) The maximum strain (Max Applied Strain) is set to 1.0%.
(6) The maximum torque (Max Allowed Torque) is set to 150.0 g cm and the minimum torque (Min Allowed Torque) is set to 0.2 g cm.
(7) The strain adjustment (Strain Adjustment) is set to 20.0% of Current Strain. The measurement is performed in the automatic tension adjustment mode (Auto Tension).
(8) The automatic tension direction (Auto Tension Direction) is set to compression.
(9) The initial static force (Initial Static Force) is set to 10.0 g and the automatic tension sensitivity (Auto Tension Sensitivity) is set to 40.0 g.
(10) In the operating conditions for automatic tension (Auto Tension), the sample modulus is 1.0×10³ Pa or greater.
Step (i): Measurements are performed while raising the temperature from 30° C. to 100° C. at a rate of 2° C./min to obtain a curve G′₁(T) of storage elastic modulus G′[Pa] versus temperature T [° C.].
Step (ii): After step (i), measurements are performed while lowering the temperature from 100° C. to 30° C. at a rate of 2° C./min to obtain a curve G′₂(T) of storage elastic modulus G′[Pa] versus temperature T [° C.].
Step (iii): after step (ii), the temperature is raised from 30° C. to 100° C. at a rate of 2° C./min to obtain a curve G′₃(T) of storage elastic modulus G′[Pa] versus temperature T [° C.].

The measurement results on storage elastic modulus G′ obtained in the above measurement are plotted as a temperature-storage elastic modulus curve, with temperature on the horizontal axis and the common logarithm log G′ of the storage elastic modulus G′ on the vertical axis. After plotting, the temperature-storage elastic modulus curve is obtained by smoothly connecting the points.

Next, the slope of the obtained temperature-storage elastic modulus curve is determined, and a differential curve obtained by differentiating the common logarithm log G′ with respect to temperature is plotted. In this way, where the storage elastic modulus of the toner at temperature T (° C.) is denoted by G′(T), a graph can be obtained with temperature T on the horizontal axis and the value d(log G′(T))/dT obtained by differentiating log G′(T) with respect to temperature T on the vertical axis.

For curve G′₂(T), the same procedure is used to obtain a graph with temperature T on the horizontal axis and the value d(log G′₂(T))/dT obtained by differentiating log G′₂(T) with respect to temperature T on the vertical axis.

In the graph with the obtained temperature T on the horizontal axis and the value d(log G′₂(T))/dT obtained by differentiating log G′₂(T) with respect to temperature T on the vertical axis, the minimum value within the range of 50.0 to 70.0° C. is identified, and the temperature at which this minimum value is obtained is designated as temperature T2 (° C.). Where there are multiple minimum values within the range of 50.0 to 70.0° C., the smallest and lowest value is designated as the minimum value, and the corresponding temperature is selected as T2. The value of d(log G′₂(T2))/dT is then obtained.

The values of G′₁(100), G′₃(50), G′₃(70), and G′₃(70)/G′₂(70) are also obtained.

If it is difficult to smoothly connect the points in the temperature-storage elastic modulus plots, the measured values may be smoothed to make it easier to connect the points smoothly. The smoothing method used is the simple moving average method based on plotting three points before and after.

Method for Separating Materials from Toner

Materials comprised in toner can be separated from the toner by utilizing the difference in solubility of each material in the solvent.

First Separation: toner is dissolved in methyl ethyl ketone (MEK) at 23° C., and a soluble fraction (amorphous resin) and an insoluble fraction (crystalline resin, wax, colorant, inorganic filler particles, etc.) are separated.

Second Separation: the insoluble fraction (crystalline resin, wax, colorant, inorganic filler particles, etc.) obtained in the first separation is dissolved in MEK at 100° C., and a soluble fraction (crystalline resin, wax) and an insoluble fraction (colorant, inorganic filler particles, etc.) are separated.

Third Separation: the soluble fraction (crystalline resin, wax) obtained in the second separation is dissolved in chloroform at 23° C., and a soluble fraction (crystalline resin) an insoluble fraction (wax) are separated.

Measurement of Content of Crystalline Resin, Amorphous Resin, and Inorganic Filler Particles in Binder Resin of Toner

The masses of the soluble and insoluble fractions are measured in each separation step to calculate the content of crystalline resin and amorphous resin in the binder resin of the toner.

### Calculation of Content Ratio of Monomer Units in Amorphous Polyester Resin A, Amorphous Polyester Resin B, and Crystalline Polyester Resin

The content of constituent monomers in amorphous polyester resin A, amorphous polyester resin B, and crystalline polyester resin is calculated using NMR in the following manner.

A total of 5 mg of the resin to be measured is weighed out and dissolved in deuterated THF or deuterated chloroform, ¹H-NMR measurement is performed, and the composition ratio is calculated from the integrated value of each peak. Specific instrument conditions are described hereinbelow.

### Measurement Conditions

Measurement device: JNM-ECA400FT-NMR (JEOL)
Measurement nucleus: ¹H
Solvent: deuterated THF or deuterated chloroform
Measurement frequency: 400 MHz
Pulse width: 5.0 μs
Frequency range: 10,500 Hz
Number of accumulations: 64
Measurement temperature: room temperature

Aend, Cend, Cal, and Cca can be calculated from the results obtained.

Method for Measuring Melting Points and Endothermic Peaks of Toner, Resin, etc.

The melting points and endothermic peaks of toner, resin, etc. are measured using a DSC Q1000 (manufactured by TA Instruments) under the following conditions.
Heating rate: 10° C./min
Starting temperature: 20° C.
Ending temperature: 180° C.

The melting points of indium and zinc are used for temperature correction of the device detector, and the heat of fusion of indium is used for calorific value correction. Specifically, a 5 mg sample is weighed and placed in an aluminum pan for differential scanning calorimetry. An empty silver pan is used as a reference. The peak temperature of the maximum endothermic peak during the first temperature rise process is taken as the melting point. The maximum endothermic peak refers to the peak with the largest endothermic value when there are multiple peaks. The endothermic value of this maximum endothermic peak is then determined. The attribution of each peak can be determined by performing DSC measurements on each individual material separated from the toner that is described hereinabove.

The melting point Tc of the crystalline resin and the melting point Tw of the wax can also be obtained.

### Method for Measuring Glass Transition Temperature of Toner, Resin, Etc.

As with the above measurements of the melting point, endothermic peak, and endothermic amount of toner and resin, measurements are performed using a DSC Q1000 (manufactured by TA Instruments) under the following conditions. Measurements are performed within a measurement range of 20 to 180° C. at a temperature rise rate of 10° C./min. During the measurement, the resin temperature is first raised to 200° C. and held for 10 min, then lowered to 20° C., and then raised again. During this second temperature rise process, the specific heat change is measured in the temperature range of 20 to 100° C. The intersection of the line midway between the baselines before and after the specific heat change and the differential thermal curve is taken as the glass transition temperature (Tg) of the toner, resin, etc.

### Method for Measuring Resin Softening Point (Tm)

The softening point of a resin is measured using a constant-load extrusion capillary rheometer, “Flow Tester CFT-500D Flow Property Evaluation Device” (manufactured by Shimadzu Corporation), according to the manual provided with the device. With this device, a constant load is applied from above the measurement sample using a piston, while the sample filled in the cylinder is heated and melted. The molten measurement sample is then extruded from a die at the bottom of the cylinder, yielding a flow curve showing the relationship between the piston descend amount and temperature.

The “Melting Temperature in 1/2 Method” described in the manual provided with “Flow Tester CFT-500D Flow Property Evaluation Device” is taken as the softening point. The melting temperature in the 1/2 Method is calculated in the following manner.

First, half of the difference between the piston descent amount at the point in time when the outflow ends (outflow end point, Smax) and the piston descent amount at the pint in time when the outflow begins (minimum point, Smin) (this is taken as X; X=(Smax−Smin)/2). The temperature on the flow curve when the piston descent amount is the sum of X and Smin is the melting temperature according to the 1/2 Method.

The measurement sample is prepared by compressing 1.0 g of resin at 10 MPa for 60 sec using a tablet compression machine (e.g., NT-100H, manufactured by NPa System Co., Ltd.) at 25° C., to form a cylinder with a diameter of 8 mm.

Specific measurement operations are performed according to the manual provided with the device.

The measurement conditions for the CFT-500D are as follows:
Test mode: temperature rise method
Starting temperature: 50° C.
Final temperature: 200° C.
Measurement interval: 1.0° C.
Temperature rise rate: 4.0° C./min
Piston cross-sectional area: 1.000 cm²
Test load (piston load): 10.0 kgf (0.9807 MPa)
Preheat time: 300 sec
Diameter of die hole: 1.0 mm
Length of die: 1.0 mm

### Method for Determining Number of Carbon Atoms for Maximum Peak of Wax

The number of carbon atoms for the maximum peak of wax is measured in the following manner. Thermal desorption is performed using the ATD (Auto Thermal Desorption) method. The following measurement device is used.

Thermal desorption apparatus: TurboMatrix ATD (PerkinElmer Corp.)

GC/MS: TRACE DSQ (Thermo Fisher Scientific Inc.)

### Preparation of Glass Tube Containing Internal Standard

A glass tube for the thermal desorption apparatus is prepared in advance by sandwiching 10 mg of Tenax TA adsorbent between glass wool, and conditioning is performed at 300° C. for 3 h under an inert atmosphere. A total of 5 L of a 100 ppm methanol solution of deuterated n-hexadecane (n-hexadecane D34) is then adsorbed onto the Tenax TA to create a glass tube comprising an internal standard.

Deuterated n-hexadecane, which has a different retention time, is used as an internal standard to distinguish the peak from the peak of n-hexadecane comprised in the wax, as mentioned above. All volatile component concentrations are converted to deuterated n-hexadecane. The method for converting volatile component concentrations is described below.

### Measurement of Wax

A total of 1 mg of weighed wax is wrapped in aluminum foil baked at a temperature 300° C. and placed in a dedicated tube prepared in Preparation of Glass Tube Containing an Internal Standard. The sample is covered with a Teflon (registered trademark) cap for the thermal desorption apparatus and placed in the thermal desorption apparatus. This sample is measured under the following conditions, and the retention time of the volatile components of the internal standard is calculated.

### Thermal Desorption Apparatus Conditions

Tube temperature: 200° C.
Transfer temperature: 300° C.
Valve temperature: 300° C.
Column pressure: 150 kPa
Inlet split: 25 ml/min.
Outlet split: 10 ml/min.
Secondary adsorption tube material: Tenax TA
Retention time: 10 min.
Secondary adsorption tube temperature during desorption: −30° C.
Secondary adsorption tube desorption temperature: 300° C.
   GC/MS conditions
Column: Ultraalloy (metal column) UT-5 (inner diameter 0.25 mm, liquid phase 0.25 m, length 30 m)
Column temperature rise conditions: 60° C. (holding time 3 min), temperature rise from 60° C. to 350° C. (temperature rise rate 20.0° C./min), 350° C. (holding time 10 min)

The transfer line of the thermal desorption apparatus is directly connected to the GC column; the GC injection port is not used.

### Analysis

Among all the peaks after the retention time of n-hexadecane, excluding the peak of deuterated n-hexadecane, which is the internal standard, of the peaks obtained by the above operations, the maximum peak is identified and the corresponding number Wmax of carbon atoms is calculated.

Method for Measuring Weight-Average Molecular Weight (Mw) of THF-Soluble Fractions, Such as Resins, Using Gel Permeation Chromatography (GPC)

The weight-average molecular weight (Mw) of tetrahydrofuran (THF)-soluble fractions, such as resins, is measured using gel permeation chromatography (GPC) in the following manner.

First, toner is dissolved in tetrahydrofuran (THF) at room temperature for 24 h. The resulting solution is then filtered through a solvent-resistant membrane filter, “Myshori Disc” (manufactured by Tosoh Corporation), with a pore size of 0.2 m to obtain a sample solution. The sample solution is adjusted so that the concentration of components soluble in THF is 0.8% by mass. Measurements are then performed using this sample solution under the following conditions.
Apparatus: HLC8320 GPC (Detector: RI) (manufactured by Tosoh Corporation)
Column: Shodex LF-404, LF-404 (manufactured by Showa Denko K.K.)
Eluent: tetrahydrofuran (THF)
Flow rate: 1.0 ml/min
Oven temperature: 40.0° C.
Sample injection volume: 0.10 ml

To calculate the molecular weight of the sample, a molecular weight calibration curve prepared using standard polystyrene resins (e.g., “EasiVial PS-H Polystyrene,” manufactured by Agilent Technologies, Inc.) is used.

### Method for Measuring Weight-Average Particle Diameter (D4) of Toner

The volume average particle diameter (Dv) (weight average particle diameter (D4)) of the toner are calculated as follows. The measurement device used is a particle counting and analysis device “CDA-1000×” with a 100 μm aperture tube using a pore electrical resistance method (commercially available from Sysmex Corporation). The measurement conditions are set and measurement data is analyzed using bundled dedicated software “CDA-1000× (commercially available from Sysmex Corporation).”

As the electrolyte aqueous solution used for the measurement, for example, “Cellpack” (commercially available from Sysmex Corporation) can be used.

Here, before performing the measurement and analysis, dedicated software is set as follows.

On the “measurement condition setting” screen of the dedicated software, the total count number is set to 50,000, the number of repeated measurements is set to 1, and the measurement mode is set to the total count (no limit).

A specific measurement method is as follows.
(1) 150 mL of an electrolyte aqueous solution is put into a special glass round-bottom beaker, which is set on a sample stage, and stirred with a stirring propeller at 500 rpm. Then, the user clicks “blank check measurement” on the dedicated software to start the measurement, and confirms that the count number is less than 500. When the count number is 500 or more, the beaker and the aperture are washed repeatedly.
(2) 30 mL of the electrolyte aqueous solution is put into a 100 mL flat-bottomed glass beaker. 0.3 mL of a diluted solution prepared by diluting “Contaminon N” (a 10 mass % aqueous solution of a neutral detergent with pH 7 for washing precision measurement instruments, comprising a nonionic surfactant, an anionic surfactant, and an organic builder, commercially available from Wako Pure Chemical Industries, Ltd.) three mass times by weight with deionized water is added as a dispersing agent thereto.
(3) An ultrasonic disperser with an electrical output of 120 W “Ultrasonic Dispension System Tetra150” (commercially available from Nikkaki Bios Co., Ltd.), which incorporates two oscillators with an oscillation frequency of 50 kHz and with phases shifted by 180 degrees, is prepared. 3.3 L of deionized water is put into a water tank of the ultrasonic disperser, and 2 mL of Contaminon N is added to this water tank.
(4) The beaker in (2) is set in a beaker fixing hole of the ultrasonic disperser, and the ultrasonic disperser is operated. Then, the height position of the beaker is adjusted so that the resonance state of the liquid surface of the electrolyte aqueous solution in the beaker is maximized.
(5) While ultrasonic waves are emitted to the electrolyte aqueous solution in the beaker in (4), 10 mg of the toner is added little by little and dispersed. In addition, an ultrasonic dispersion treatment is additionally continued for 60 seconds. Here, during ultrasonic dispersion, the water temperature in the water tank is appropriately adjusted to be from 10° C. to 40° C.
(6) In the round-bottom beaker in (1) placed in the sample stand, the electrolyte aqueous solution in (5) in which the toner is dispersed using a pipette is added dropwise, and the measurement concentration is adjusted to 6%. Then, the measurement is performed until the number of particles measured reaches 50,000.
(7) The measurement data is analyzed using device bundled dedicated software, the volume average particle diameter (Dv) (weight average particle diameter (D4)) are calculated.

### EXAMPLES

The basic configuration and features of the present disclosure have been described above. The following examples will explain the present disclosure in more detail. However, the present disclosure is in no way limited to these examples. In the following formulations, parts are by mass unless otherwise specified.

### Production Example of Crystalline Resin 1

Ethylene glycol (49 mol %; 20.1 parts by mass)
Dodecanedioic acid (48 mol %; 73.1 parts by mass)
Behenic acid (3 mol %; 6.8 parts by mass)
Tin 2-ethylhexanoate: 0.5 parts by mass

The above materials were weighed into a reaction vessel equipped with a condenser, a stirrer, a nitrogen introduction tube, and a thermocouple. A flask was then purged with nitrogen gas, and the temperature was gradually raised while stirring. The reaction was carried out for 3 h at 140° C. while stirring.

Tin 2-ethylhexanoate was added in an amount of 0.5% by mass relative to the total mass of the monomers, followed by the addition of the above materials. The pressure in the reaction vessel was reduced to 8.3 kPa, and the reaction was carried out for 4 h while maintaining the temperature at 200° C. The pressure in the reaction vessel was then gradually released and returned to atmospheric pressure, yielding crystalline resin 1. The physical properties are shown in Table 1.

### Production Example of Crystalline Resins 2 to 9

Crystalline resins 2 to 9 were obtained by carrying out the reaction in the same manner as in the production example of crystalline resin 1, except that the materials used were changed to those in Table 1 and the parts by mass were changed so that the mol % was as shown in Table 1.

The physical properties are shown in Table 1.

TABLE 1

| | | | | | | | | | | | | | Physical | |
|---|---|---|---|---|---|---|---|---|---|---|---|---|---|---|
| | Alcohol | | | Carboxylic acid component | | | | | | | | | properties | |
| Crystalline | component | | | Adipic | Octanoic | Decanedioic | Dodecanedioic | Tetradecanedioic | | | | | Tc | |
| resin No. | EG | HG | TDD | acid | acid | acid | acid | acid | TDA | HDA | SA | BA | (° C.) | Mwc |
| 1 | 49 | — | — | — | — | — | 48 | — | — | — | — | 3 | 87 | 22000 |
| 2 | — | 49 | — | — | 49 | — | — | — | — | — | — | 2 | 82 | 20000 |
| 3 | 49 | — | — | — | — | 49 | — | — | — | — | — | 2 | 84 | 26000 |
| 4 | 49 | — | — | — | 48 | — | — | — | — | — | 3 | — | 78 | 21000 |
| 5 | 49 | — | — | — | — | — | 48 | — | — | 3 | — | — | 86 | 23000 |
| 6 | 49 | — | — | — | — | — | 48 | — | 3 | — | — | — | 84 | 23000 |
| 7 | — | 50 | — | — | — | — | 50 | — | — | — | — | — | 72 | 16000 |
| 8 | — | — | 50 | — | — | — | — | 50 | — | — | — | — | 92 | 18000 |
| 9 | 50 | — | — | 50 | — | — | — | — | — | — | — | — | 65 | 17000 |

The numerical values for each material in Table 1 indicate mol %. Tc indicates the melting point.

The abbreviations in Table 1 are as follows. The number in parentheses indicates the number of carbon atoms in the linear alkyl compound.
EG: ethylene glycol
HG: 1,6-hexanediol
TDD: 1,14-tetradecanediol
TDA: tetradecanoic acid (14)
HDA: hexadecanoic acid (16)
SA: stearic acid (18)
BA: behenic acid (22)

### Production Example of Amorphous Resin A1

The following materials were placed in a reaction vessel equipped with a reflux condenser, a stirrer, a thermometer, and a nitrogen introduction tube under a nitrogen atmosphere.
Polyoxyethylene (2.0)-2,2-bis(4-hydroxyphenyl)propane: 72.6 parts by mass (49.0 mol %)
Terephthalic acid: 21.4 parts by mass (40.0 mol %)
Adipic acid: 4.2 parts by mass (9.0 mol %)
Stearic acid: 1.8 parts by mass (2.0 mol %)
Titanium tetrabutoxide: 2.0 parts by mass

Next, a flask was purged with nitrogen gas, followed by gradually raising the temperature while stirring, performing stirring at a temperature of 200° C., and carrying out the reaction for 2 h while distilling off the water produced. The pressure inside the reaction vessel was then reduced to 8.3 kPa and maintained at this temperature for 1 h, followed by cooling to 180° C. and returning to atmospheric pressure (first reaction step).

The above materials were then added, the pressure inside the reactor was reduced to 8.3 kPa, and the reaction was continued for 4 h while maintaining the temperature at 150° C. The reaction was then stopped by lowering the temperature (second reaction step), yielding amorphous resin 1. The amorphous resin had a glass transition temperature Tg of 53° C. and a softening point of 92° C. The physical properties are shown in Table 2.

### Production Example of Amorphous Resins A2 to A11

Amorphous resins A2 to A11 were obtained by carrying out the reaction in the same manner as in the production example of amorphous resin A1, except that the materials used were changed to those shown in Table 2 and the parts by mass were changed so that the mol % was as shown in Table 2.

The physical properties are shown in Table 2.

TABLE 2

| Amorphous | | | | | | | | | | | | | | |
|---|---|---|---|---|---|---|---|---|---|---|---|---|---|---|
| resin A | BPA-PO | BPA-EO | | | Hexanoic | Tetradecanoic | Hexadecanoic | | | | | | Tg | Tm |
| No. | (2.0) | (2.0) | AA | TPA | acid | acid | acid | SA | BA | LA | TDI | Mwa | (° C.) | (° C.) |
| A1 | 49 | — | 9 | 40 | — | — | — | 2 | — | — | — | 6500 | 53 | 92 |
| A2 | 49 | — | 9 | 40 | — | — | — | — | — | 2 | — | 5000 | 52 | 95 |
| A3 | 49 | — | 8 | 40 | — | — | — | — | 3 | — | — | 7000 | 53 | 94 |
| A4 | 49 | — | 8.5 | 40 | — | — | 2.5 | — | — | — | — | 5500 | 52 | 91 |
| A5 | 49 | — | 5 | 42 | — | — | — | — | — | — | 4 | 9800 | 50 | 90 |
| A6 | 49 | — | 5 | 42 | — | 4 | — | — | — | — | — | 9800 | 50 | 93 |
| A7 | 49 | — | 3 | 42 | 6 | — | — | — | — | — | — | 12000 | 56 | 101 |
| A8 | 50 | — | 2 | 48 | — | — | — | — | — | — | — | 13000 | 61 | 112 |
| A9 | 50 | — | 12 | 38 | — | — | — | — | — | — | — | 15000 | 47 | 122 |
| A10 | — | 50 | 2 | 48 | — | — | — | — | — | — | — | 11000 | 54 | 96 |
| A11 | — | 49.5 | 0 | 49 | — | 1.5 | — | — | — | — | — | 17000 | 54 | 97 |

The numerical values for each material in Table 2 indicate mol %. Mwa indicates the weight-average molecular weight. Tg indicates the glass transition temperature, and Tm indicates the softening point. The abbreviations are as indicated below. The numbers in parentheses indicate the number of carbon atoms in the linear alkyl compound.
BPA-PO: polyoxypropylene (2.0)-2,2-bis(4-hydroxyphenyl)propane
BPA-EO: polyoxyethylene (2.0)-2,2-bis(4-hydroxyphenyl)propane
TPA: terephthalic acid
AA: adipic acid
SA: stearic acid (18)
BA: behenic acid (22)
LA: lignoceric acid (24)
TD1: tetradecanol (14)

### Production Example of Amorphous Resin B1

Bisphenol A propylene oxide adduct (average number of moles added: 2.0 mol): 72.6 parts by mass (50.0 mol %)
Terephthalic acid: 13.2 parts by mass (25.0 mol %)
Adipic acid: 7.0 parts by mass (15.0 mol %)
Titanium tetrabutoxide (esterification catalyst): 0.5 parts by mass

The above materials were weighed into a reaction vessel equipped with a condenser, a stirrer, a nitrogen introduction tube, and a thermocouple. A flask was then purged with nitrogen gas, and the temperature was gradually raised while stirring. The reaction was continued for 2 h at 200° C. while stirring.

The pressure inside the reaction vessel was then reduced to 8.3 kPa and maintained for 1 h, followed by cooling to 160° C. and returning to atmospheric pressure.
Trimellitic anhydride: 6.7 parts by mass (10.0 mol %)

The above materials were then added, the pressure in the reaction vessel was reduced to 8.3 kPa, and the reaction was carried out while maintaining the temperature at 200° C. Once the softening point was confirmed to have reached the temperature shown in Table 3, the temperature was lowered to stop the reaction, yielding amorphous polyester resin B1.

The physical properties are shown in Table 3.

TABLE 3

| | BPA-PO | | | | | Tg | Tm |
|---|---|---|---|---|---|---|---|
| Amorphous resin B | (2.0) | AA | TPA | TMA | Mwb | (° C.) | (° C.) |
| Amorphous resin B1 | 50 | 15 | 25 | 10 | 120000 | 58 | 145 |

Mwb indicates the weight-average molecular weight. Tg indicates the glass transition temperature, and Tm indicates the softening point.
Abbreviations are as follows:
BPA-PO: polyoxypropylene (2.0)-2,2-bis(4-hydroxyphenyl)propane
TPA: terephthalic acid
AA: adipic acid
TMA: trimellitic anhydride

### Production Example of Graft Polymer Resin C1

Polyethylene (Mw: 1400, Mn: 850, DSC endothermic peak at 100° C.): 20 parts by mass
Styrene: 59 parts by mass
n-Butyl acrylate: 18.5 parts by mass
Acrylonitrile: 2.5 parts by mass

The above raw materials were charged into an autoclave, and the system was purged with nitrogen. The temperature was then raised and maintained at 180° C. while stirring. A total of 50 parts by mass of a 2% by mass solution of di-tert-butyl peroxide in xylene was continuously added dropwise to the system over 5 h. After cooling, the solvent was separated and removed to obtain graft polymer resin C1, which had a structure in which a vinyl resin component and a hydrocarbon compound were bonded.

Graft polymer resin C1 had a softening point (Tm) of 110° C. and a glass transition temperature (Tg) of 64° C. The molecular weight of the Tif-soluble fraction measured by GPC was a weight-average molecular weight (Mw) of 7400 of the THF-soluble fraction. No peaks corresponding to polyethylene of the raw material were confirmed.

### Wax

The following waxes were used.

TABLE 4

| | | Melting point | |
|---|---|---|---|
| Wax | Type | Tw/° C. | Wmax |
| Wax 1 | Fischer-Tropsch wax | 90 | 42 |
| Wax 2 | Fischer-Tropsch wax | 77 | 36 |
| Wax 3 | Ester wax (behenyl behenate) | 81 | 44 |

### Production Example of Toner Particle 1

Crystalline resin 1: 9 parts by mass
Amorphous resin A1: 52 parts by mass
Amorphous resin B1: 23 parts by mass
Graft polymer resin C1: 5 parts by mass
Wax 1: 5 parts by mass
Colorant 1: 5 parts by mass

(Cyan pigment, Pigment Blue 15:3, manufactured by Dainichiseika Color & Chem. MFG Co., Ltd.)

The above materials were mixed using a Henschel mixer (FM-75, manufactured by Nippon Coke and Engineering Co., Ltd.) at a rotation speed of 25 s⁻¹ for 5 min, and then kneaded in a twin-screw kneader (PCM-30, Ikegai Corporation) set at 120° C. with a screw rotation speed of 250 rpm and a discharge temperature of 130° C.

The resulting resin composition was cooled to room temperature and coarsely pulverized to 1 mm or less using a hammer mill to obtain a coarsely pulverized product. The resulting coarsely pulverized product was then finely pulverized using a mechanical pulverizer (T-250, manufactured by Freund Turbo Corporation).

Further classification was performed using Faculty F-300 (manufactured by Hosokawa Micron Corporation), resulting in toner particle 1 with a weight-average particle diameter (D4) of 6.0 μm, an average circularity of 0.965, and a domain number-average diameter of 0.20 μm. The operating conditions were a classification rotor rotation speed of 130 s⁻¹ and a dispersion rotor rotation speed of 120 s⁻¹.

### Production Examples of Toner Particles 2 to 26

Toner particles 2 to 26 were produced in the same manner as in production example of toner particle 1, except that the type and added mass parts of crystalline resin, the type and added mass parts of amorphous resins A and B, and the type of wax were changed as shown in Table 5.

TABLE 5

| | | Raw materials constituting toner particle | | | | | | | | | | | |
|---|---|---|---|---|---|---|---|---|---|---|---|---|---|
| | | | | | | | | Graft | | | | | |
| | Toner | Crystalline | | Amorphous | | Amorphous | | polymer | | | | External additive | |
| Toner | particle | resin | | resin A | | resin B | | resin C1 | Wax | | Colorant 1 | Silica particles 1 | Toner |
| No. | No. | No. | Parts | No. | Parts | No. | Parts | Parts | Type | Parts | Parts | Parts | Total Parts |
| 1 | 1 | 1 | 9 | A1 | 52 | B1 | 23 | 5 | Wax 1 | 5 | 5 | 1 | 100 |
| 2 | 2 | 2 | 9 | A1 | 52 | B1 | 23 | 5 | Wax 1 | 5 | 5 | 1 | 100 |
| 3 | 3 | 3 | 9 | A1 | 52 | B1 | 23 | 5 | Wax 1 | 5 | 5 | 1 | 100 |
| 4 | 4 | 1 | 9 | A2 | 52 | B1 | 23 | 5 | Wax 2 | 5 | 5 | 1 | 100 |
| 5 | 5 | 1 | 9 | A2 | 52 | B1 | 23 | 5 | Wax 1 | 5 | 5 | 1 | 100 |
| 6 | 6 | 1 | 9 | A3 | 52 | B1 | 23 | 5 | Wax 1 | 5 | 5 | 1 | 100 |
| 7 | 7 | 1 | 9 | A4 | 52 | B1 | 23 | 5 | Wax 1 | 5 | 5 | 1 | 100 |
| 8 | 8 | 1 | 9 | A5 | 52 | B1 | 23 | 5 | Wax 1 | 5 | 5 | 1 | 100 |
| 9 | 9 | 1 | 9 | A6 | 52 | B1 | 23 | 5 | Wax 1 | 5 | 5 | 1 | 100 |
| 10 | 10 | 1 | 3 | A6 | 36 | B1 | 45 | 5 | Wax 1 | 5 | 5 | 1 | 100 |
| 11 | 11 | 1 | 3 | A6 | 56 | B1 | 25 | 5 | Wax 3 | 5 | 5 | 1 | 100 |
| 12 | 12 | 1 | 3 | A6 | 56 | B1 | 25 | 5 | Wax 1 | 5 | 5 | 1 | 100 |
| 13 | 13 | 1 | 6 | A6 | 56 | B1 | 22 | 5 | Wax 1 | 5 | 5 | 1 | 100 |
| 14 | 14 | 1 | 15 | A6 | 48 | B1 | 21 | 5 | Wax 1 | 5 | 5 | 1 | 100 |
| 15 | 15 | 1 | 18 | A6 | 46 | B1 | 20 | 5 | Wax 1 | 5 | 5 | 1 | 100 |
| 16 | 16 | 1 | 18 | A6 | 56 | B1 | 10 | 5 | Wax 1 | 5 | 5 | 1 | 100 |
| 17 | 17 | 1 | 9 | A7 | 52 | B1 | 23 | 5 | Wax 1 | 5 | 5 | 1 | 100 |
| 18 | 18 | 1 | 9 | A8 | 52 | B1 | 23 | 5 | Wax 1 | 5 | 5 | 1 | 100 |
| 19 | 19 | 4 | 9 | A8 | 52 | B1 | 23 | 5 | Wax 1 | 5 | 5 | 1 | 100 |
| 20 | 20 | 5 | 9 | A8 | 52 | B1 | 23 | 5 | Wax 1 | 5 | 5 | 1 | 100 |
| 21 | 21 | 6 | 9 | A8 | 52 | B1 | 23 | 5 | Wax 1 | 5 | 5 | 1 | 100 |
| 22 | 22 | — | 0 | A9 | 80 | B1 | 4 | 5 | Wax 1 | 5 | 5 | 1 | 100 |
| 23 | 23 | — | 0 | A8 | 18 | B1 | 66 | 5 | Wax 1 | 5 | 5 | 1 | 100 |
| 24 | 24 | 7 | 3 | A8 | 56 | B1 | 25 | 5 | Wax 1 | 5 | 5 | 1 | 100 |
| 25 | 25 | 8 | 3 | A10 | 56 | B1 | 25 | 5 | Wax 1 | 5 | 5 | 1 | 100 |
| 26 | 26 | 9 | 3 | A11 | 56 | B1 | 25 | 5 | Wax 2 | 5 | 5 | 1 | 100 |

### Production Example of Toner 1

Toner particle 1: 99.0 parts by mass
Silica particles 1 (silicone oil-treated fumed silica with a number-average diameter of 30 nm): 1.0 part by mass

The above materials were mixed in a Henschel Mixer FM-10C (manufactured by Mitsui Miike Chemical Engineering Co., Ltd.) at a rotation speed of 30 s⁻¹ for 5 min to obtain toner 1.

The viscoelasticity of the resulting toner was measured using the method described above and is described in Table 6.

TABLE 6

| Toner | G′₁ | G′₃ | G′₃ | G′₃(70)/ | | d(logG′2(T2))/ | Wmax − | Cend − | Cend − | Mwa/ |
|---|---|---|---|---|---|---|---|---|---|---|
| No. | (100) | (50) | (70) | G′₂(70) | T2 | dT | Aend | Aend | (Cal + Cca) | Mwc |
| Toner 1 | 7.0E+03 | 1.2E+08 | 7.5E+06 | 60.0 | 65.0 | −0.8 | 24 | 4 | 8 | 0.30 |
| Toner 2 | 8.0E+03 | 1.5E+08 | 8.0E+06 | 40.0 | 64.0 | −0.6 | 24 | 4 | 8 | 0.33 |
| Toner 3 | 3.0E+03 | 1.15+08 | 7.2E+06 | 70.0 | 66.0 | −1.1 | 24 | 4 | 10 | 0.25 |
| Toner 4 | 1.0E+03 | 7.6E+07 | 3.0E+06 | 18.0 | 57.0 | −0.3 | 12 | −2 | 8 | 0.23 |
| Toner 5 | 1.8E+04 | 1.0E+08 | 5.5E+06 | 41.0 | 68.0 | −0.6 | 18 | −2 | 8 | 0.23 |
| Toner 6 | 1.2E+04 | 1.1E+08 | 8.2E+06 | 50.0 | 65.0 | −0.6 | 20 | 0 | 8 | 0.32 |
| Toner 7 | 7.0E+03 | 9.5E+07 | 7.5E+06 | 32.0 | 62.0 | −0.6 | 26 | 6 | 8 | 0.25 |
| Toner 8 | 3.6E+04 | 8.6E+07 | 5.5E+06 | 18.0 | 62.0 | −0.5 | 28 | 8 | 8 | 0.45 |
| Toner 9 | 1.3E+04 | 8.6E+07 | 8.8E+06 | 26.0 | 62.0 | −0.6 | 28 | 8 | 8 | 0.45 |
| Toner 10 | 4.7E+04 | 5.0E+08 | 2.4E+07 | 24.0 | 62.0 | −0.4 | 28 | 8 | 8 | 0.45 |
| Toner 11 | 4.0E+04 | 1.1E+08 | 6.0E+06 | 18.0 | 62.0 | −0.6 | 30 | 8 | 8 | 0.45 |
| Toner 12 | 3.8E+04 | 3.0E+08 | 1.6E+07 | 24.0 | 62.0 | −0.6 | 28 | 8 | 8 | 0.45 |
| Toner 13 | 2.1E+04 | 2.0E+08 | 9.5E+06 | 24.0 | 62.0 | −0.6 | 28 | 8 | 8 | 0.45 |
| Toner 14 | 2.2E+03 | 8.2E+07 | 6.0E+06 | 24.0 | 62.0 | −0.6 | 28 | 8 | 8 | 0.45 |
| Toner 15 | 1.2E+03 | 7.5E+07 | 3.0E+06 | 24.0 | 62.0 | −0.6 | 28 | 8 | 8 | 0.45 |
| Toner 16 | 3.0E+02 | 7.2E+07 | 2.3E+06 | 24.0 | 62.0 | −0.9 | 28 | 8 | 8 | 0.45 |
| Toner 17 | 2.0E+03 | 8.5E+07 | 1.2E+07 | 21.0 | 61.0 | −0.4 | 36 | 16 | 8 | 0.55 |
| Toner 18 | 2.4E+03 | 8.5E+07 | 2.1E+07 | 22.0 | 59.0 | −0.4 | 42 | 22 | 8 | 0.59 |
| Toner 19 | 2.5E+03 | 4.5E+07 | 3.7E+06 | 18.0 | 59.0 | −0.4 | 42 | 18 | 8 | 0.62 |
| Toner 20 | 2.5E+03 | 8.3E+07 | 2.5E+06 | 15.0 | 59.0 | −0.3 | 42 | 16 | 4 | 0.57 |
| Toner 21 | 2.5E+03 | 8.0E+07 | 2.4E+06 | 12.0 | 59.0 | −0.3 | 42 | 14 | 0 | 0.57 |
| Toner 22 | 8.0E+02 | 6.6E+07 | 1.7E+06 | 1.1 | 45.0 | −0.2 | — | — | — | — |
| Toner 23 | 6.0E+04 | 6.0E+08 | 5.6E+07 | 0.9 | 72.0 | −0.3 | — | — | — | — |
| Toner 24 | 1.6E+04 | 2.4E+08 | 1.2E+06 | 1.1 | 52.0 | −0.3 | — | — | — | 0.81 |
| Toner 25 | 7.0E+03 | 1.2E+08 | 8.0E+05 | 2.0 | 54.0 | −0.3 | — | — | — | 0.61 |
| Toner 26 | 8.0E+03 | 9.5E+07 | 6.0E+05 | 6.0 | 50.0 | −0.3 | 28 | −14 | −8 | 1.00 |

In the table, T2 is the minimum value (° C.) in a graph with temperature T on the horizontal axis and d(log G′₂(T))/dT, which is the value obtained by differentiating log G′₂(T) with respect to temperature T, on the vertical axis.

In the table, for example, a description such as 7.0E+03 indicates 7.0×10³.

### Production Examples of Toners 2 to 26

Toners 2 to 26 were produced in the same manner as in production example of toner 1, except that the toner particles were replaced with toner particles 2 to 26, respectively. The physical properties are shown in Table 6.

### Production Example of Magnetic Carrier 1

Magnetite 1 with a number-average particle diameter of 0.30 μm (magnetization strength of 65 Am²/kg in a magnetic field of 1000/4π (kA/m))
Magnetite 2 with a number-average particle diameter of 0.50 μm (magnetization strength of 65 Am²/kg in a magnetic field of 1000/tic (kA/m))

A total of 4.0 parts of a silane compound (3-(2-aminoethylaminopropyl)trimethoxysilane) was added to 100 parts of each of the above materials, and high-speed mixing and stirring were performed in containers at 100° C. or higher to process the respective fine particles.
Phenol: 10% by mass
Formaldehyde solution: 6% by mass (40% by mass formaldehyde, 10% by mass methanol, 50% by mass water)
Magnetite 1 treated with the above silane compound: 58% by mass
Magnetite 2 treated with the above silane compound: 26% by mass

A total of 100 parts of the above materials, 5 parts of a 28% by mass aqueous ammonia solution, and 20 parts of water were placed in a flask. The temperature was raised to 85° C. over 30 min and maintained while stirring and mixing, and a polymerization reaction was carried out for 3 h to cure the resulting phenolic resin. The cured phenolic resin was then cooled to 30° C., and water was added. The supernatant was thereafter removed, and the precipitate was washed with water and air-dried. This was then dried under reduced pressure (5 mmHg or less) at 60° C. to obtain magnetic body-dispersed spherical magnetic carrier 1. The volume-based 50% particle diameter (D50) of magnetic carrier 1 was 34.2 m.

### Production Example of Two-Component Developer 1

A total of 8.0 parts of toner 1 was added to 92.0 parts of magnetic carrier 1, and the components were mixed in a V-type mixer (V-20, manufactured by Seishin Enterprise Co., Ltd.) to obtain two-component developer 1.

### Production Example of Two-Component Developers 2 to 26

Toners 2 to 26 were used in the production example of two-component developer 1 to obtain two-component developers 2 to 26, respectively.

### Example 1

### Low-Temperature Fixability

Evaluation was performed using the above two-component developer 1.

A modified Canon imageRUNNER ADVANCE C5870 digital commercial printer was used as the image forming apparatus, and two-component developer 1 was placed in a cyan developer unit. Modifications to the apparatus were made to enable free setting of fixing temperature, process speed, DC voltage VDC on a developer carrying member, charging voltage VD on an electrostatic latent image bearing member, and laser power. Image output evaluation involved outputting an FFh image (solid image) with the desired image ratio, and adjusting VDC, VD, and laser power so as to obtain the desired toner laid-on level on the FFh image on paper, thereby evaluating low-temperature fixability.

FFh is the hexadecimal representation of 256 gradations, with 00h being the first gradation (white area) of the 256 gradations and FFh being the 256th gradation (solid area).

Evaluation was performed based on the following evaluation method, and the results are shown in Table 7.
Paper: GFC-081 (81.0 g/m²)
(sold by Canon Marketing Japan Inc.)
Toner laid-on level on paper: 0.80 mg/cm²
(adjusted by the DC voltage VDC on the developer carrying member, the charging voltage VD on the electrostatic latent image bearing member, and the laser power)
Evaluation image: a 2 cm×5 cm image was placed in the center of the A4 paper
Test environment: low-temperature and low-humidity environment: 15° C. temperature/humidity 10% RH (hereinafter referred to as “L/L”)
Fixing temperature: 140° C.
Process speed: 320 mm/sec

The evaluation image was printed and low-temperature fixability was evaluated. The value of image density loss rate was used as the evaluation index for low-temperature fixability.

The image density loss rate was measured first in the center of the image using an X-Rite color reflection densitometer (500 series: manufactured by X-Rite, Inc.). Next, the fixed image was rubbed (five times back and forth) with Silbon paper under a load of 4.9 kPa (50 g/cm²) on the area where the image density was measured, and the image density was measured again. The image density decrease rate before and after rubbing was calculated using the following formula. The resulting image density decrease rate was evaluated according to the following evaluation criteria:

$$Image density decrease rate = ( Image density before rubbing - Image density after rubbing ) \text{} / ( Image density before rubbing ) \times 100$$

A rank of C or higher was determined to be excellent.

### Evaluation Criteria

A: Image density decrease rate is less than 1.0%
B: Image density decrease rate is 1.0% or more but less than 3.0%
C: Image density decrease rate is 3.0% or more but less than 8.0%
D: Image density decrease rate is 8.0% or more

### Heat-Resistant Storage Stability

A total of 5 g of toner was placed in a 100 mL plastic cup and allowed to stand in a temperature- and humidity-variable thermostat (50° C., humidity 54% RH) for 72 h, and the aggregation property was thereafter evaluated. The aggregation property was evaluated by shaking the resulting toner through a 150 μm mesh with a 0.5 mm amplitude for 10 sec using Powder Tester PT-X manufactured by Hosokawa Micron Corporation. As an evaluation index, the residual rate of the toner remaining on the mesh was calculated from the mass of the toner on the mesh before and after shaking, and rank C or higher was determined to be excellent.

### Evaluation Criteria

A: Residual rate is less than 2.0%
B: Residual rate is 2.0% or more but less than 5.0%
C: Residual rate is 5.0% or more but less than 10.0%
D: Residual rate is 10.0% or more

### Image Defects During Double-Sided Printing

The evaluation was performed based on the following evaluation method by using the same image forming apparatus as was used for evaluating the low-temperature fixability. To more clearly demonstrate the effects of the present disclosure, the evaluation was conducted in an environment with a temperature and humidity higher than those of the normal usage environment.

The results are shown in Table 7.
Paper: Mondi Color Copy (300 g/m²) (Sold by Mondi plc)
Toner laid-on level on paper: 0.80 mg/cm² (adjusted by the DC voltage VDC on the developer carrying member, the charging voltage VD on the electrostatic latent image bearing member, and the laser power)
Evaluation image: a 25 cm wide×20 cm long FFh image was printed on both sides of the A3 paper with a 5 mm margin from the leading edge in the transport direction.
Test environment: high-temperature and high-humidity environment: 35° C./humidity 80% RH
Fixing temperature: 160° C.
Process speed: 320 mm/sec
Number of outputs: 10,000

The 9,000th through 10,000th output images were evaluated. The whiteness of the white background of the output image and the whiteness of the evaluation paper were measured using a “REFLECTOMETER MODEL TC-6DS” (manufactured by Tokyo Denshoku Co., Ltd.). The difference between the whiteness of the evaluation paper and the worst-case whiteness of the white background of the output image was used as a fogging density (%) to evaluate image defects during double-sided printing. An amber filter was used as a filter. A rank of C or higher was determined to be excellent.

### Evaluation Criteria

A: Fogging density of all images under evaluation is less than 1.0%.
B: Fogging density of all images under evaluation is 1.0% or more but less than 2.0%.
C: The proportion of evaluation images with a fogging density of 2.0% or more was less than 2.0% of the images under evaluation.
D: The proportion of evaluation images with a fogging density of 2.0% or more was 2.0% or more of the images under evaluation.

### Fusion to Drum

The evaluation was performed based on the following evaluation method by using the same image forming apparatus as was used for evaluating the low-temperature fixability.

The results are shown in Table 7.
Paper: CS-068 (68.0 g/m²) (Sold by Canon Marketing Japan Inc.)
Toner laid-on level on paper: 0.80 mg/cm² (adjusted by the DC voltage VDC on the developer carrying member, the charging voltage VD on the electrostatic latent image bearing member, and the laser power)
Evaluation image: an FFh image was arranged on one side of the A4 paper with an image print ratio of 40%.
Test environment: high-temperature and high-humidity environment:
temperature 35° C./humidity 80% RH
Fixing temperature: 160° C.
Process speed: 320 mm/sec
Number of outputs: 100,000

After continuous output ended, the surface of the electrostatic latent image bearing member was observed with a Digital High-Vision Microscope VQ-7000 (manufactured by Keyence Corporation) (300× magnification). Locations with fused toner within the field of view were marked, and area thereof was calculated to determine the percentage of the area covered by fused toner within the field of view. This was observed in 20 fields of view across the entire surface of the electrostatic latent image bearing member, and the average value was taken as the fusion occurrence rate. This evaluation was performed three times, and a rank was determined from the average. The evaluation was ranked as follows. The evaluation results are shown in Table 7. Rank C or higher was determined to be excellent.

### Evaluation Criteria

A: Fusion occurrence rate is less than 1.0%
B: Fusion occurrence rate is 1.0% or more but less than 5.0%
C: Fusion occurrence rate is 5.0% or more but less than 10.0%
D: Fusion occurrence rate is 10.0% or higher

### Charge Stability

The evaluation was performed based on the following evaluation method by using the same image forming apparatus as was used for evaluating the low-temperature fixability.

The results are shown in Table 7.
Paper: CS-068 (68.0 g/m²) (sold by Canon Marketing Japan Inc.)
Toner laid-on level on paper: 0.40 mg/cm² (adjusted by the DC voltage VDC on the developer carrying member, the charging voltage VD on the electrostatic latent image bearing member, and the laser power)
Evaluation image: an FFh image arranged on one side of the A4 paper with an image print ratio of 2%.
Test environment: high-temperature and high-humidity environment:
temperature 30° C./humidity 80% RH
Fixing temperature: 160° C.
Process speed: 320 mm/sec

A total of 3,000 sheets were printed under the above conditions. After allowing the printer to stand for one day, one sheet of the same evaluation image was output. The image density of the resulting image was measured and compared to the image density of the first printed sheet output before alloying the printer to stand for one day. The image density change rate was calculated as follows:

$$Image density change rate ( \% ) = \vert 1 - ( Image density after allowing the printer to stand for one day ) \text{} / ( Image density of first sheet before allowing the printer to stand for one day ) \vert \times 100$$

Evaluation was performed according to the following criteria. A rank of C or higher was determined to be excellent.

### Evaluation Criteria

A: Image density change rate is less than 2.0%.
B: Image density change rate is 2.0% or more but less than 5.0%.
C: Image density change rate is 5.0% or more but less than 10.0%.
D: Image density change rate is 10.0% or more.

### Examples 2 to 21 and Comparative Examples 1 to 5

Evaluation was performed in the same manner as in Example 1, except that two-component developers 2 to 26 were used instead of two-component developer 1.

The evaluation results are shown in Table 7.

TABLE 7

| | | | Evaluation of toner characteristics | | | | | | | | | |
|---|---|---|---|---|---|---|---|---|---|---|---|---|
| | | | Low-temperature | | | | | | | | | |
| | | Two- | fixability | | Heat-resistant | | Image defects | | Fusion to drum | | Charge stability | |
| | | component | | Density | storage stability | | during double- | | | Fusion | | Density |
| | Toner | developer | | decrease | | Residual | sided printing | | | occurrence | | change |
| | No. | No. | Rank | rate (%) | Rank | rate (%) | Rank | X/Y | Rank | rate (%) | Rank | rate (%) |
| Example 1 | 1 | 1 | A | 0.6 | A | 0.9 | A | 0.6/0 | A | 0.6 | A | 0.8 |
| Example 2 | 2 | 2 | A | 0.6 | A | 0.9 | A | 0.7/0 | A | 0.6 | A | 0.8 |
| Example 3 | 3 | 3 | A | 0.6 | A | 1.2 | A | 0.7/0 | A | 0.6 | A | 0.9 |
| Example 4 | 4 | 4 | A | 0.8 | C | 8.0 | B | 1.8/0 | C | 7.0 | A | 1.0 |
| Example 5 | 5 | 5 | A | 0.7 | B | 4.2 | B | 1.6/0 | B | 3.0 | A | 1.0 |
| Example 6 | 6 | 6 | A | 0.7 | A | 1.0 | A | 0.8/0 | A | 0.8 | A | 1.0 |
| Example 7 | 7 | 7 | A | 0.7 | A | 1.5 | A | 0.8/0 | A | 0.8 | A | 1.2 |
| Example 8 | 8 | 8 | B | 1.2 | B | 2.4 | B | 1.6/0 | B | 4.0 | A | 1.5 |
| Example 9 | 9 | 9 | A | 0.8 | B | 3.0 | B | 1.370 | B | 4.0 | A | 1.5 |
| Example 10 | 10 | 10 | C | 7.0 | A | 1.0 | B | 1.5/0 | B | 4.0 | A | 1.8 |
| Example 11 | 11 | 11 | B | 2.5 | B | 2.2 | C | 3.0/1.2 | C | 8.0 | A | 1.8 |
| Example 12 | 12 | 12 | B | 1.6 | B | 2.4 | B | 1.4/0 | B | 4.5 | A | 1.8 |
| Example 13 | 13 | 13 | A | 0.8 | B | 2.6 | B | 1.2/0 | B | 4.5 | A | 1.6 |
| Example 14 | 14 | 14 | A | 0.8 | B | 2.8 | B | 1.3/0 | B | 4.5 | A | 1.7 |
| Example 15 | 15 | 15 | A | 0.8 | C | 7.0 | C | 2.4/1.5 | C | 7.5 | B | 3.2 |
| Example 16 | 16 | 16 | A | 0.8 | C | 8.0 | C | 3.0/1.9 | C | 7.9 | B | 4.0 |
| Example 17 | 17 | 17 | A | 0.8 | C | 9.0 | B | 1.7/0 | C | 8.6 | C | 6.4 |
| Example 18 | 18 | 18 | A | 0.8 | C | 8.0 | B | 1.8/0 | C | 9.2 | C | 7.3 |
| Example 19 | 19 | 19 | A | 0.8 | C | 8.5 | C | 3.2/1.7 | C | 8.2 | Charge stability | 6.9 |
| Example 20 | 20 | 20 | A | 0.8 | C | 8.5 | C | 2.9/1.6 | C | 8.0 | C | 7.1 |
| Example 21 | 21 | 21 | A | 0.8 | C | 8.5 | C | 3.3/1.8 | C | 9.2 | C | 8.0 |
| Comparative | 22 | 22 | A | 0.8 | D | 14.0 | D | 4.5/5 | D | 15.0 | C | 8.1 |
| Example 1 | | | | | | | | | | | | |
| Comparative | 23 | 23 | D | 15.0 | B | 4.0 | B | 1.5/0 | C | 7.0 | B | 4.0 |
| Example 2 | | | | | | | | | | | | |
| Comparative | 24 | 24 | A | 0.8 | C | 9.5 | D | 6.0/4 | D | 17.0 | C | 8.2 |
| Example 3 | | | | | | | | | | | | |
| Comparative | 25 | 25 | A | 0.9 | C | 9.0 | D | 4.1/3.5 | D | 13.0 | C | 9.6 |
| Example 4 | | | | | | | | | | | | |
| Comparative | 26 | 26 | A | 0.9 | C | 9.0 | D | 4.0/4.5 | D | 12.0 | C | 7.9 |
| Example 5 | | | | | | | | | | | | |

In the table, “X” indicates the maximum fogging density, and “Y” indicates the proportion (0%) of evaluation images with a fogging density of 2.00% or more.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-206551, filed Nov. 27, 2024, which is hereby incorporated by reference herein in its entirety.

What is claimed is:

1. A toner comprising a toner particle comprising a binder resin and a wax, wherein
the binder resin comprises a crystalline resin;
in measuring a viscoelasticity of the toner,
step (i): the temperature is raised from 30° C. to 100° C. at a rate of 2° C./min to obtain a curve G′₁(T) of storage elastic modulus G′[Pa] versus temperature T [° C.],
step (ii): after the step (i), the temperature is lowered from 100° C. to 30° C. at a rate of 2° C./min to obtain a curve G′₂(T) of storage elastic modulus G′[Pa] versus temperature T [° C.],
step (iii): after the step (ii), the temperature is raised from 30° C. to 100° C. at a rate of 2° C./min to obtain a curve G′₃(T) of storage elastic modulus G′[Pa] versus temperature T [° C.]; and
where the storage elastic modulus G′ at 100° C. on the curve G′₁(T) is denoted by G′₁(100) [Pa], the storage elastic modulus G′ at 70° C. on the curve G′₂(T) is denoted by G′₂(70) [Pa], the storage elastic modulus G′ at 50° C. on the curve G′₃(T) is denoted by G′₃(50) [Pa], and the storage elastic modulus G′ at 70° C. on the curve G′₃(T) is denoted by G′₃(70) [Pa],
the G′₁(100), the G′₂(70), the G′₃(50), and the G′₃(70) satisfy the following formulas (1) to (4).
$${G}_{1}^{′} ( 100 ) \leq 5. \times 1 {0}^{4} Pa \qquad ( 1 )$$
$${G}_{3}^{′} ( 50 ) \geq 7.0 \times 1 {0}^{7} Pa \qquad ( 2 )$$
$${G}_{3}^{′} ( 70 ) \geq 2.0 \times 1 {0}^{6} Pa \qquad ( 3 )$$
$${G}_{3}^{′} ( 70 ) / {G}_{2}^{′} ( 70 ) \geq 10 \qquad ( 4 )$$

2. The toner according to claim 1, wherein
in a graph of the curve G′₂(T) in which a horizontal axis represents the temperature T and a vertical axis represents a value d(log G′₂(T))/dT obtained by differentiating log G′₂(T) with respect to the temperature T,
there is a minimum value in a range of 55.0 to 70.0° C., and
where a temperature at which the minimum value is observed is denoted by T2 (° C.),
$$d ( log {G}_{2}^{′} ( T 2 ) ) / dT is - 2. to - 0.3 .$$

3. The toner according to claim 1, wherein the binder resin further comprises an amorphous polyester resin A, wherein
the amorphous polyester resin A has a molecular chain terminal condensed with at least one linear alkyl compound A selected from the group consisting of aliphatic linear monocarboxylic acids and aliphatic linear monoalcohols, and
where a number of carbon atoms in the linear alkyl compound A is denoted by Aend and
a number of carbon atoms corresponding to a peak detected as a maximum peak when the wax is analyzed by GC/MS is denoted by Wmax,
the Aend and the Wmax satisfy the following relationships:
$$Aend \geq 16$$
$$16 \geq Wmax - Aend \leq 30.$$

4. The toner according to claim 1, wherein
the crystalline resin comprises a crystalline polyester resin, and
the crystalline polyester resin has a structure in which at least one linear alkyl compound C selected from the group consisting of monohydric alcohols and monovalent carboxylic acids is condensed at a molecular chain terminal.

5. The toner according to claim 4, wherein
the binder resin further comprises an amorphous polyester resin A, and
the amorphous polyester resin A has a molecular chain terminal condensed with at least one linear alkyl compound A selected from the group consisting of aliphatic linear monocarboxylic acids and aliphatic linear monoalcohols.

6. The toner according to claim 5, wherein
where a number of carbon atoms in the linear alkyl compound A is denoted by Aend and a number of carbon atoms in the linear alkyl compound C is denoted by Cend,
the Aend and the Cend satisfy the following relationships:
$$Cend \geq 16$$
$$- 4 \leq Cend - Aend \leq 6.$$

7. The toner according to claim 1, wherein
the crystalline polyester resin comprises a condensation polymer of a monomer composition comprising an aliphatic diol and an aliphatic dicarboxylic acid, and
where a number of carbon atoms in the aliphatic diol in the crystalline polyester resin is denoted by Cal, a number of carbon atoms in the aliphatic dicarboxylic acid is denoted by Cca, and a number of carbon atoms in the linear alkyl compound C is denoted by Cend,
the Cal, the Cca, and the Cend satisfy the following relationship:
$$Cend - ( Cal + Cca ) \geq 8.$$

8. The toner according to claim 5, wherein the linear alkyl compound A comprises an aliphatic linear monocarboxylic acid.

9. The toner according to claim 5, wherein
where a weight-average molecular weight of a THF-soluble fraction of the amorphous polyester resin A is denoted by Mwa and a weight-average molecular weight of a THF-soluble fraction of the crystalline polyester resin is denoted by Mwc,
the Mwa and the Mwc satisfy Mwa/Mwc≤0.50.
